(19) United States
(12) Patent Application Publication
(10) Pub. No.: US 2026/0171318 A1
(43) Pub. Date: Jun. 18, 2026

(54) CAPACITOR AND METHOD OF MANUFACTURING THE SAME

(71) Applicant: Murata Manufacturing Co., Ltd., Nagaokakyo-shi (JP)

(72) Inventors: Yuuto YAMAMOTO, Nagaokakyo-shi (JP); Naoki IWAJI, Nagaokakyo-shi (JP); Akio MASUNARI, Nagaokakyo-shi (JP); Tatsuki NISHIJIMA, Nagaokakyo-shi (JP)

(21) Appl. No.: 19/533,881

(22) Filed: Feb. 9, 2026

Related U.S. Application Data
(63) Continuation of application No. PCT/JP2024/032343, filed on Sep. 10, 2024.

(30) Foreign Application Priority Data
Sep. 11, 2023 (JP) 2023-146810

(51) Int. Cl. H01G 4/228; H01G 4/224

(52) U.S. Cl. CPC H01G 4/228; H01G 4/224

(57) ABSTRACT

A capacitor includes an insulating substrate including a main surface, a capacitance generating portion on the main surface, and first and second external connection wiring lines connected to the capacitance generating portion. The capacitance generating portion includes an uneven or porous conductive structure connected to the first external connection wiring line, a dielectric film covering a surface of the uneven or porous conductive structure, a conductive film covering a portion of the dielectric film and connected to the second external connection wiring line, and an uneven outermost surface. The dielectric film includes an exposed portion not covered by the conductive film and a non-exposed portion covered by the conductive film. The capacitance generating portion includes an outer edge portion in a direction parallel or substantially parallel to the main surface. The outer edge portion is defined by the exposed portion.

### CROSS REFERENCE TO RELATED APPLICATIONS

This application claims the benefit of priority to Japanese Patent Application No. 2023-146810 filed on Sep. 11, 2023 and is a Continuation Application of PCT Application No. PCT/JP2024/032343 filed on Sep. 10, 2024. The entire contents of each application are hereby incorporated herein by reference.

### BACKGROUND OF THE INVENTION

### 1. Field of the Invention

The present invention relates to capacitors each including a capacitance generating portion that includes a conductive structure, a dielectric film, and a conductive film, and to methods of manufacturing the same.

### 2. Description of the Related Art

For example, Japanese Unexamined Patent Application Publication No. 2003-249417, Japanese Unexamined Patent Application Publication No. 2008-130778, and Japanese Unexamined Patent Application Publication No. 2009-49212 each disclose a capacitor including a capacitance generating portion that includes a conductive structure including a plurality of columnar bodies, a dielectric film covering a surface of the structure, and a conductive film covering the dielectric film.

Furthermore, United States Patent Application Publication No. 2018/0277306 discloses a capacitor in which a conductive structure includes a porous metal body instead of a plurality of columnar bodies. In the capacitor disclosed in United States Patent Application Publication No. 2018/0277306, the porous metal body of the structure is formed of a sintered body of metal particles, and the dielectric layer and the conductive film are both formed by atomic layer deposition (ALD). In this capacitor, the capacitance generating portion has an uneven outermost surface.

In a capacitor including a capacitance generating portion having an uneven outermost surface, as in the capacitor disclosed in the aforementioned United States Patent Application Publication No. 2018/0277306, film stress occurring in a dielectric film, a conductive film, and so forth or externally applied stress may concentrate at an outer edge portion of the capacitance generating portion after mounting, which may cause cracks or other breakage at the outer edge portion. Such a damaged portion is prone to short circuits, resulting in loss of functionality as a capacitor.

### SUMMARY OF THE INVENTION

Example embodiments of the present invention increase reliability after mounting of capacitors each including a capacitance generating portion that includes a conductive structure, a dielectric film, and a conductive film, and methods for manufacturing such capacitors.

A capacitor according to an example embodiment of the present invention includes an insulating substrate including a main surface, a capacitance generating portion on the main surface, and a first external connection wiring line and a second external connection wiring line connected to the capacitance generating portion. The capacitance generating portion includes an uneven or porous conductive structure connected to the first external connection wiring line, a dielectric film covering a surface of the structure, and a conductive film covering a portion of the dielectric film and connected to the second external connection wiring line. The capacitance generating portion includes an uneven outermost surface. The dielectric film includes an exposed portion not covered by the conductive film and a non-exposed portion covered by the conductive film. The capacitance generating portion includes an outer edge portion in a direction parallel or substantially parallel to the main surface, the outer edge portion being defined by the exposed portion.

A method of manufacturing a capacitor according to an example embodiment of the present invention, the method including preparing an insulating substrate including a main surface, forming a first external connection wiring line on or in the insulating substrate, forming an uneven or porous conductive structure on the main surface, forming a first dielectric film so as to cover a surface of the structure, after the structure and the first external connection wiring line are connected to each other, forming a conductive film so as to cover a surface of the first dielectric film thus forming a capacitance generating portion including the structure, the first dielectric film, and the conductive film and including an uneven outermost surface, after the first dielectric film has been formed, forming a second external connection wiring line connected to the conductive film after the capacitance generating portion has been formed, forming a resist film so as to cover a portion of a surface of the second external connection wiring line corresponding to a portion other than an outer edge portion of the conductive film in a direction parallel or substantially parallel to the main surface after the conductive film and the second external connection wiring line are connected to each other, removing a portion of the second external connection wiring line not covered by the resist film, and a portion of the conductive film covered by the portion of the second external connection wiring line after the resist film has been formed, and removing the resist film after the portion of the second external connection wiring line and the portion of the conductive film have been removed.

A method of manufacturing a capacitor according to another example embodiment of the present invention, the method including preparing an insulating substrate including a main surface, forming a first external connection wiring line on or in the insulating substrate, forming an uneven or porous conductive structure on the main surface, forming a first dielectric film so as to cover a surface of the structure after the structure and the first external connection wiring line are connected to each other, forming a second dielectric film with adhesion to a conductive film so as to cover a surface of the first dielectric film after the first dielectric film has been formed, forming a third dielectric film with no adhesion to the conductive film so as to cover a surface of an outer edge portion of the second dielectric film in a direction parallel or substantially parallel to the main surface after the second dielectric film has been formed, forming the conductive film so as to cover a surface of a portion of the second dielectric film not covered by the third dielectric film, thus forming a capacitance generating portion including the structure, the first dielectric film, the second dielectric film, the third dielectric film, and the conductive film and including an uneven outermost surface after the third dielectric film has been formed, and forming a second external connection wiring line connected to the conductive film after the capacitance generating portion has been formed.

A method of manufacturing a capacitor according to another example embodiment of the present invention, the method including preparing an insulating substrate including a main surface, forming a first external connection wiring line on or in the insulating substrate, forming an uneven or porous conductive structure on the main surface, forming a first dielectric film so as to cover a surface of the structure after the structure and the first external connection wiring line are connected to each other, forming a resist film so as to cover an outer edge portion of the first dielectric film in a direction parallel or substantially parallel to the main surface after the first dielectric film has been formed, forming a second dielectric film with adhesion to a conductive film so as to cover the resist film and a portion of the first dielectric film not covered by the resist film after the resist film has been formed, removing the resist film and a portion of the second dielectric film covering the resist film after the second dielectric film has been formed, forming, after the resist film and the portion of the second dielectric film have been removed, the conductive film so as to cover a surface of a portion of the second dielectric film that has not been removed, thus forming a capacitance generating portion including the structure, the first dielectric film, the second dielectric film, and the conductive film and including an uneven outermost surface, and forming a second external connection wiring line connected to the conductive film after the capacitance generating portion has been formed.

According to example embodiments of the present invention, reliability after mounting of capacitors each including a capacitance generating portion that includes a conductive structure, a dielectric film, and a conductive film is increased.

The above and other elements, features, steps, characteristics and advantages of the present invention will become more apparent from the following detailed description of the example embodiments with reference to the attached drawings.

### BRIEF DESCRIPTION OF THE DRAWINGS

FIGS. 1A and 1B include a schematic front view and a schematic plan view of a capacitor according to a first example embodiment of the present invention.

FIG. 2 is a schematic sectional view of the capacitor illustrated in FIGS. 1A and 1B.

FIGS. 3A and 3B include enlarged sectional views of main portions of a capacitance generating portion illustrated in FIG. 2.

FIG. 4 is a flowchart illustrating an example of a method of manufacturing a capacitor according to the first example embodiment of the present invention.

FIG. 5 is a schematic sectional view for describing step S5 of the manufacturing flow illustrated in FIG. 4.

FIG. 6 is a schematic sectional view for describing step S6 of the manufacturing flow illustrated in FIG. 4.

FIG. 7 is a schematic sectional view for describing step S7 of the manufacturing flow illustrated in FIG. 4.

FIG. 8 is a schematic sectional view for describing step S8 of the manufacturing flow illustrated in FIG. 4.

FIG. 9 is a schematic sectional view for describing step S9 of the manufacturing flow illustrated in FIG. 4.

FIG. 10 is a schematic sectional view for describing step S10 of the manufacturing flow illustrated in FIG. 4.

FIG. 11 is a schematic sectional view for describing step S11 of the manufacturing flow illustrated in FIG. 4.

FIG. 12 is a schematic sectional view for describing step S12 of the manufacturing flow illustrated in FIG. 4.

FIG. 13 is a schematic sectional view for describing step S13 of the manufacturing flow illustrated in FIG. 4.

FIG. 14 is a schematic sectional view for describing step S14 of the manufacturing flow illustrated in FIG. 4.

FIG. 15 is a schematic sectional view for describing step S15 of the manufacturing flow illustrated in FIG. 4.

FIG. 16 is a schematic sectional view for describing step S16 of the manufacturing flow illustrated in FIG. 4.

FIG. 17 is a schematic sectional view of a capacitor according to a first modification of an example embodiment of the present invention.

FIG. 18 is a schematic sectional view of a capacitor according to a second modification of an example embodiment of the present invention.

FIG. 19 is a schematic sectional view of a capacitor according to a second example embodiment of the present invention.

FIGS. 20A and 20B include enlarged sectional views of main portions of a capacitance generating portion illustrated in FIG. 19.

FIG. 21 is a flowchart illustrating an example of a method of manufacturing a capacitor according to the second example embodiment of the present invention.

FIG. 22 is a schematic sectional view for describing step S9B1 of the manufacturing flow illustrated in FIG. 21.

FIG. 23 is a schematic sectional view for describing step S9B2 of the manufacturing flow illustrated in FIG. 21.

FIG. 24 is a schematic sectional view for describing step S10 of the manufacturing flow illustrated in FIG. 21.

FIG. 25 is a schematic sectional view of a capacitor according to a third example embodiment of the present invention.

FIGS. 26A and 26B include enlarged sectional views of main portions of a capacitance generating portion illustrated in FIG. 25.

FIG. 27 is a flowchart illustrating a method of manufacturing a capacitor according to the third example embodiment of the present invention.

FIG. 28 is a schematic sectional view for describing step S12 of the manufacturing flow illustrated in FIG. 27.

FIG. 29 is a schematic sectional view for describing step S9B1 of the manufacturing flow illustrated in FIG. 27.

FIG. 30 is a schematic sectional view for describing step S14 of the manufacturing flow illustrated in FIG. 27.

FIG. 31 is a schematic sectional view for describing step S10 of the manufacturing flow illustrated in FIG. 27.

FIG. 32 is a schematic sectional view of a capacitor according to a fourth example embodiment of the present invention.

FIGS. 33A and 33B include enlarged sectional views of main portions of a capacitance generating portion illustrated in FIG. 32.

FIG. 34 is a flowchart illustrating an example of a method of manufacturing a capacitor according to the fourth example embodiment of the present invention.

FIG. 35 is a schematic sectional view illustrating a state after step S5 of the manufacturing flow illustrated in FIG. 34 is completed.

FIG. 36 is a schematic sectional view for describing step S5D of the manufacturing flow illustrated in FIG. 34.

FIG. 37 is a schematic sectional view of a capacitor according to a fifth example embodiment of the present invention.

FIGS. 38A and 38B include enlarged sectional views of main portions of a capacitance generating portion illustrated in FIG. 37.

FIG. 39 is a flowchart illustrating an example of a method of manufacturing a capacitor according to the fifth example embodiment of the present invention.

FIG. 40 is a schematic sectional view of a capacitor according to a sixth example embodiment of the present invention.

FIGS. 41A and 41B include enlarged sectional views of main portions of a capacitance generating portion illustrated in FIG. 40.

FIG. 42 is a flowchart illustrating an example of a method of manufacturing a capacitor according to the sixth example embodiment of the present invention.

FIG. 43 is a schematic sectional view of a capacitor according to a seventh example embodiment of the present invention.

FIG. 44 is a flowchart illustrating an example of a method of manufacturing a capacitor according to the seventh example embodiment of the present invention.

FIG. 45 is a schematic sectional view of a capacitor according to an eighth example embodiment of the present invention.

FIG. 46 is a schematic sectional view of a capacitor according to a ninth example embodiment of the present invention.

### DETAILED DESCRIPTION OF THE EXAMPLE EMBODIMENTS

Hereinafter, example embodiments of the present invention will be described in detail with reference to the accompanying drawings. In the following example embodiments, the same or common portions are denoted by the same reference numerals in the drawings, and the description thereof will not be repeated. In the following example embodiments, the terms “anode” and “cathode” are used for the sake of convenience of description, but the electrical polarity of a capacitor in the following example embodiments is not uniquely determined by these terms and is determined as appropriate in accordance with the environment in which the capacitor is used.

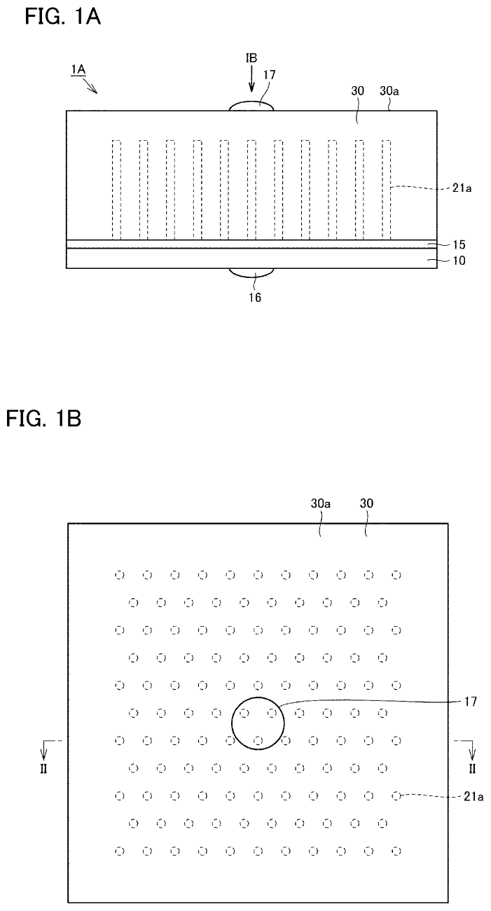

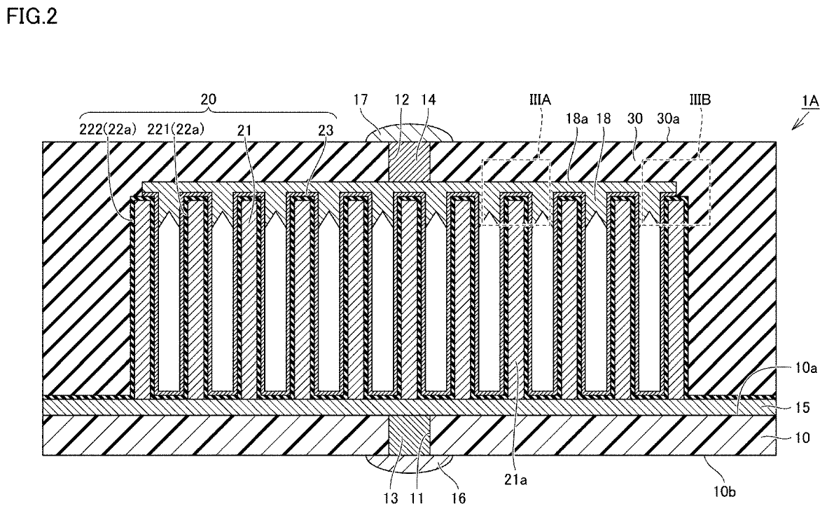

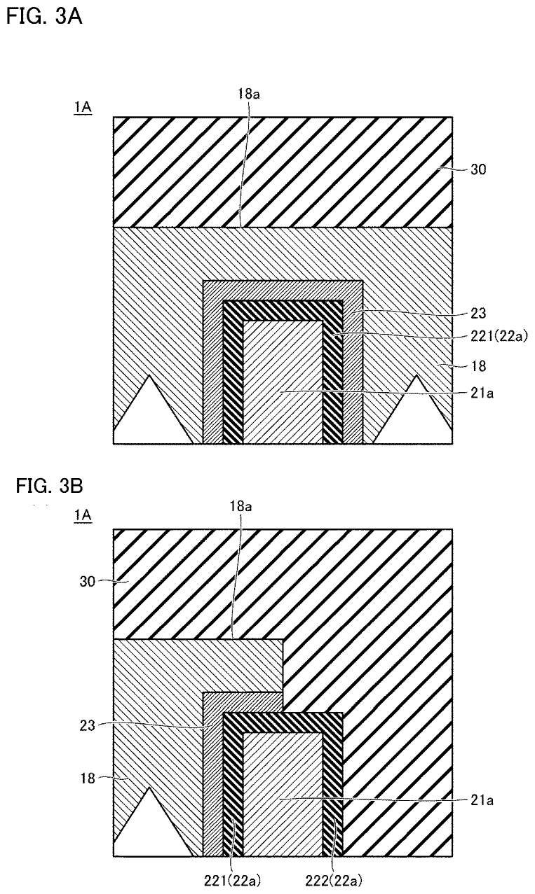

FIG. 1A is a schematic front view of a capacitor according to a first example embodiment of the present invention. FIG. 1B is a schematic plan view of the capacitor viewed in the direction of arrow IB illustrated in FIG. 1A. FIG. 2 is a schematic sectional view of the capacitor taken along line II-II illustrated in FIG. 1(B). FIGS. 3A and 3B are enlarged main-part sectional views of region IIIA and region IIIB, respectively, of a capacitance generating portion illustrated in FIG. 2. First, the configuration of a capacitor 1A according to the present example embodiment will be described with reference to FIGS. 1A and 1B to FIGS. 3A and 3B.

As illustrated in FIGS. 1A and 1B and FIG. 2, the capacitor 1A has a flat, rectangular or substantially rectangular parallelepiped outer shape, and the bottom and top surfaces thereof each define and function as a mounting surface for a wiring board or the like. The capacitor 1A mainly includes an insulating substrate 10, a capacitance generating portion 20, and a sealing portion 30. Among them, the capacitance generating portion 20 is opposed to the insulating substrate 10. The capacitance generating portion 20 is sealed by the insulating substrate 10 and the sealing portion 30 disposed on the insulating substrate 10, thus being located in an inner portion of the capacitor 1A.

The insulating substrate 10 includes a first via conductor 13 therein and a first bump 16 thereon. The first via conductor 13 and the first bump 16 define one of a pair of external connection wiring lines to electrically connect the capacitance generating portion 20, which is located in the inner portion of the capacitor 1A, to an external circuit. More specifically, the pair of external connection wiring lines includes a first external connection wiring line defining and functioning as an anode and a second external connection wiring line defining and functioning as a cathode, and the first via conductor 13 and the first bump 16 define a portion of the first external connection wiring line. The second external connection wiring line includes a lead-out electrode 18, a second via conductor 14, and a second bump 17, which will be described below.

The insulating substrate 10 includes a flat-plate-shaped member including a first main surface 10a, which defines and functions as a main surface, and a second main surface 10b located opposite to the first main surface 10a. The insulating substrate 10 may preferably be an electrically insulating substrate, and may preferably be a substrate mainly including an inorganic material. More specifically, the insulating substrate 10 may be a substrate mainly including, for example, any one of Si, Al₂O₃, ZrO₂, BN, Si₃N₄, AlN, MgO, Mg₂SiO₄, BaTiO₃, SrTiO₃, or CaTiO₃.

The thickness and size of the insulating substrate 10 are not particularly limited, but it is preferable to use an alumina substrate that is rectangular or substantially rectangular in plan view, for example, with a thickness of about 5 μm or more and about 75 μm or less and a side length of about 500 μm or more and about 2000 μm or less.

The insulating substrate 10 includes a first through hole 11 therein. The first through hole 11 extends from the first main surface 10a to the second main surface 10b through the insulating substrate 10. The first through hole 11 is filled with the first via conductor 13. The first via conductor 13 has, for example, a cylindrical or substantially cylindrical shape.

The first via conductor 13 defines a portion of the above-described first external connection wiring line. The first via conductor 13 is disposed within a region where the capacitance generating portion 20 is disposed, when viewed in the normal direction of the first main surface 10a of the insulating substrate 10.

The first via conductor 13 can be made of any of various wiring materials, but is particularly preferably made of a metal material having high electrical conductivity. The first via conductor 13 can be made of, for example, a metal material mainly including any one of Ni, Ag, Cu, Au, Pt, Mo, or W. The material of the first via conductor 13 can be changed as appropriate in accordance with the environment in which the capacitor 1A according to the present example embodiment is mounted. In the present example embodiment, the first via conductor 13 is made of Ni, for example.

The axial length and size of the first via conductor 13 are not particularly limited, and are set as appropriate in accordance with the thickness and size of the insulating substrate 10. Here, the first via conductor 13 preferably has an axial length of, for example, about 5 μm or more and about 75 μm or less, and a diameter of, for example, about 15 μm or more and about 150 μm or less. In the present example embodiment, for example, the first via conductor 13 is made of Ni and has an axial length of about 75 μm and a diameter of about 150 μm.

On the second main surface 10b of the insulating substrate 10, the first bump 16 is disposed so as to cover the first via conductor 13. The first bump 16 defines and functions as a bonding member to mount the capacitor 1A on a wiring board or the like and to electrically connect the capacitance generating portion 20 of the capacitor 1A to an external circuit. The first bump 16 is disposed so as to protrude from the second main surface 10b of the insulating substrate 10. The first bump 16 has a hemispherical or substantially hemispherical shape. The first bump 16 defines a portion of the above-described first external connection wiring line.

The first bump 16 can be made of any of various wiring materials, but is particularly preferably made of a metal material having high electrical conductivity. The first bump 16 can be made of, for example, a metal material mainly including any one of Ni, Ag, Cu, Au, or Sn. In the present example embodiment, the first bump 16 is made of Au, for example.

The size of the first bump 16 is not particularly limited, and is set as appropriate in accordance with the size of the first via conductor 13.

On the first main surface 10a of the insulating substrate 10, a connection conductor 15 is disposed so as to cover the first via conductor 13. Accordingly, the connection conductor 15 is electrically connected to the first via conductor 13.

Here, the connection conductor 15 includes, for example, a conductive layer having a predetermined thickness. In the present example embodiment, the connection conductor 15 includes a single conductive layer and is disposed so as to cover the entire or substantially the entire first main surface 10a. The connection conductor 15 defines a portion of the above-described first external connection wiring line.

The connection conductor 15 can be made of any of various wiring materials, but is particularly preferably made of a metal material having high electrical conductivity. The connection conductor 15 can be made of, for example, a metal material mainly including any one of Ni, Ag, Cu, Au, Pt, Mo, Ti, Cr, or W. The connection conductor 15 may be made of an alloy material mainly including two or more of these metal materials.

The thickness and size of the connection conductor 15 are not particularly limited. In particular, the size thereof is set as appropriate in accordance with the size of insulating substrate 10. In the present example embodiment, for example, the connection conductor 15 is made of Ni and has a thickness of about 200 nm.

According to the above, the first external connection wiring line defining and functioning as an anode of the pair of external connection wiring lines includes the first via conductor 13, the connection conductor 15, and the first bump 16.

As illustrated in FIG. 2, the capacitance generating portion 20 is opposed to the first main surface 10a of the insulating substrate 10, and includes a conductive structure 21, a first dielectric film 22a covering the surface of the structure 21, and a conductive film 23 covering a portion of the surface of the first dielectric film 22a. The capacitance generating portion 20 includes an uneven outermost surface.

The structure 21 has an uneven shape including a plurality of conductive columnar bodies 21a extending from the first main surface 10a of the insulating substrate 10 with the connection conductor 15 interposed therebetween.

The plurality of columnar bodies 21a are formed by, for example, a Lithographie Galvanoformung Abformung (LIGA) process, which is a combination of X-ray lithography and electroforming. The method of forming the plurality of columnar bodies 21a is not particularly limited to this, and can be changed as appropriate.

The structure 21 is located on the connection conductor 15 and is joined to the connection conductor 15. Thus, the above-described first external connection wiring line defining and functioning as an anode is connected to the capacitance generating portion 20 via the connection conductor 15.

The columnar bodies 21a defining the structure 21 can be made of any of various conductive metal materials, but is preferably made of a metal material mainly including any one of Ni, Mo, W, Al, Ti, Ta, Nb, Cu, Pt, Au, or Ag. The columnar bodies 21a may be made of an alloy material mainly including two or more of these metal materials. In the present example embodiment, the columnar bodies 21a are made of Ni, for example.

The number and size of the columnar bodies 21a defining the structure 21 are not particularly limited, and are set as appropriate in accordance with the size of the insulating substrate 10. In the present example embodiment, for example, the columnar bodies 21a each have a cylindrical or substantially cylindrical shape with a length of about 500 μm or less and a diameter of about 1 μm or more. FIG. 1B illustrates 116 columnar bodies 21a as a whole arranged in a staggered pattern, whereas FIG. 2 illustrates 11 columnar bodies 21a among them. These numbers and arrangements are merely examples and can be changed in various ways.

The first dielectric film 22a covers the surface of the structure 21, as described above. The first dielectric film 22a also covers the surface of a portion of the connection conductor 15 that is not joined to the columnar bodies 21a. In the present example embodiment, the first dielectric film 22a corresponds to a dielectric film.

The first dielectric film 22a can be made of any of various insulating materials, for example, metal oxides such as AlOₓ, SiOₓ, HfOₓ, TiOₓ, TaOₓ, ZrOₓ, SiAlOₓ, HfAlOₓ, ZrAlOₓ, AlTiOₓ, SrTiOₓ, HfSiOₓ, ZrSiOₓ, TiZrOₓ, TiZrOₓ, TiZrWOₓ, SrTiOₓ, BaTiOₓ, PbTiOₓ, BaSrTiOₓ, or BaCaTiOₓ, metal nitrides such as AlNₓ, SiNₓ, or AlScNₓ, and metal oxynitrides such as AlOₓN_{y}, SiOₓN_{y}, HfOₓN_{y}, or SiCₓO_{y}N_{z}. Among these, for example, it is preferable that the first dielectric film 22a is made of any one of AlOₓ (for example, Al₂O₃), SiOₓ (for example, SiO₂), HfOₓ, TiOₓ, SiAlOₓ, HfAlOₓ, ZrAlOₓ, HfSiOₓ, or ZrSiOₓ. The above chemical formulas simply indicate the structure of the materials and do not limit the composition. That is, x, y, and z attached to O and N may be any value greater than 0, and the abundance ratio of each element including a metal element is not specified. The first dielectric film 22a may include a laminated film including a plurality of dielectric layers made of different materials. In the present example embodiment, for example, the first dielectric film 22a is made of either AlOₓ or SiOₓ.

The first dielectric film 22a can be preferably formed by a gas phase method, for example, vacuum deposition, chemical vapor deposition (CVD), sputtering, atomic layer deposition (ALD), or pulsed laser deposition (PLD), or a method using a supercritical fluid, and is particularly preferably formed by ALD, for example.

The thickness of the first dielectric film 22a is not particularly limited, but is, for example, preferably about 3 nm or more and about 100 nm or less, and more preferably about 5 nm or more and about 50 nm or less.

The conductive film 23 covers a portion of the surface of the first dielectric film 22a, as described above. Accordingly, the first dielectric film 22a includes a non-exposed portion 221 that is covered by the conductive film 23 and an exposed portion 222 that is not covered by the conductive film 23.

More specifically, as illustrated in FIG. 2 and FIG. 3A, of the first dielectric film 22a, a portion other than a portion defining an outer edge portion of the capacitance generating portion 20 in a direction parallel or substantially parallel to the first main surface 10a of the insulating substrate 10 (i.e., both end portions in the right-left direction in FIG. 2) has its surface covered by the conductive film 23, thus defining and functioning as the non-exposed portion 221. On the other hand, as illustrated in FIG. 2 and FIG. 3B, of the first dielectric film 22a, the portion defining the outer edge portion has its surface not covered by the conductive film 23, thus defining and functioning as the exposed portion 222.

This configuration makes it possible to increase the reliability of the capacitor 1A that has been mounted, the details of which will be described below.

The conductive film 23 can be made of any of various conductive materials, such as, for example, a metal material mainly including any one of Ni, Cu, Ru, Al, W, Ti, Ag, Au, Zn, Ta, or Nb, an alloy material mainly including two or more of these metal materials, a metal nitride such as TiN, TiAlN, TiSiN, TaN, NbN, or WN, a metal oxynitride such as TiON or TiAlON, a conductive polymer such as poly(3,4-ethylenedioxythiophene) (PEDOT), polypyrrole, or polyaniline, or a conductive oxide film such as RuO₂, ZnO, (Zn, Al)O, or NiO. In the present example embodiment, the conductive film 23 is made of Ru, for example.

The conductive film 23 can be preferably formed by, for example, CVD, ALD, PLD, plating, bias sputtering, a sol-gel method, a method using conductive polymer filling, or a method using a supercritical fluid, and is particularly preferably formed by ALD. The conductive film 23 may include a laminated film including a plurality of conductive layers made of different materials. In this case, film formation can be performed by, for example, ALD and then film formation can be performed by another method.

The thickness of the conductive film 23 is not particularly limited, but is, for example, preferably about 3 nm or more, and more preferably about 10 nm or more.

As illustrated in FIG. 2, most of an upper portion of the capacitance generating portion 20 is covered by the lead-out electrode 18 and is electrically connected thereto. More specifically, the lead-out electrode 18 is located so as to cover the surface of a portion of the conductive film 23 covering the non-exposed portion 221 in the portion covering tip end portions of the columnar bodies 21a. On the other hand, the lead-out electrode 18 does not cover the portion of the conductive film 23 other than the above-described portion or the surface of the exposed portion 222. The lead-out electrode 18 defines a portion of the above-described second external connection wiring line.

The lead-out electrode 18 can be made of any of various conductive materials, such as, for example, a metal material mainly composed of any one of Ni, Cu, Al, Pt, Ti, or TiN, an alloy material mainly including two or more of these metal materials, or a metal nitride such as TiN. In the present example embodiment, the lead-out electrode 18 is made of either Cu or Ti, for example. The lead-out electrode 18 is formed by, for example, sputtering, vacuum deposition, CVD, or the like.

As illustrated in FIG. 2, the sealing portion 30 is disposed on the first main surface 10a of the insulating substrate 10 and seals the capacitance generating portion 20 together with the insulating substrate 10. The sealing portion 30 defines an outer surface 30a located opposite to the insulating substrate 10 side as viewed from the capacitance generating portion 20. More specifically, the sealing portion 30 is located so as to cover the side portions and a portion of the upper portion of the capacitance generating portion 20, which is opposed to the first main surface 10a of the insulating substrate 10, and the upper and side portions of the lead-out electrode 18.

The sealing portion 30 can be made of any of various insulating materials, but is particularly preferably made of an insulating material that is excellent in weather resistance. The sealing portion 30 can be made of, for example, a resin material such as a polyimide resin, a polybenzoxazole resin, a polyethylene terephthalate resin, a benzocyclobutene resin, or an epoxy resin. The resin material may include any of various additives, such as an SiO₂ filler or an Al₂O₃ filler, for example, to adjust the thermal expansion coefficient. In the present example embodiment, the sealing portion 30 is made of an epoxy resin, for example.

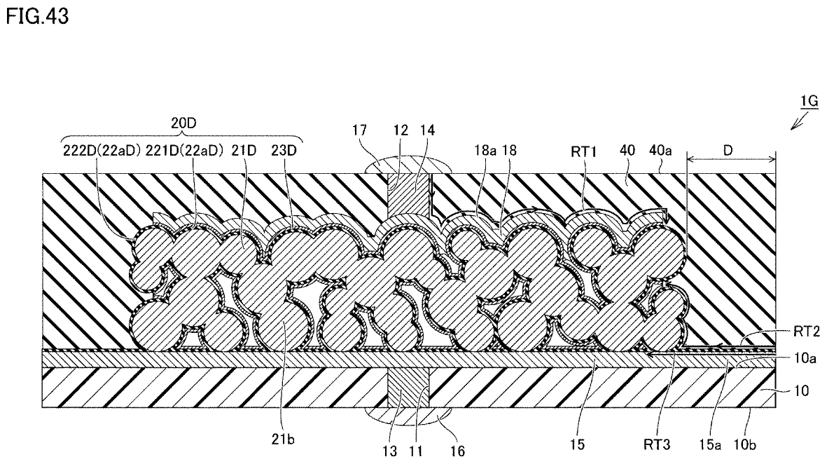

When the sealing portion 30 alone is insufficient to ensure moisture resistance, a moisture-resistant protective film 40 (see FIG. 43 and so forth) may be provided between the capacitance generating portion 20 and the sealing portion 30. The moisture-resistant protective film 40 can be formed, for example, by providing an inorganic insulator made of SiN, SiO₂, Al₂O₃, HfO₂, ZrO₂, or the like to cover the capacitance generating portion 20 by CVD, ALD, or the like, or by providing an organic insulator having water repellency, such as a fluorine-based resin or a silane coupling agent resin, to cover the capacitance generating portion 20, before forming the sealing portion 30. Here, the moisture-resistant protective film 40 does not necessarily need to be provided inside the capacitance generating portion 20, but it suffices that the moisture-resistant protective film 40 is provided so as to cover only the outer surface of the capacitance generating portion 20.

The sealing portion 30 can be formed by any of various coating methods, such as, for example, a method using a vacuum laminator, a method using an air dispenser, a method using a jet dispenser, a screen printing method, a vacuum printing method, an electrostatic coating method, an inkjet method, or a photolithography method.

The thickness and size of the sealing portion 30 are not particularly limited, and the size is set as appropriate in accordance with the size of the insulating substrate 10. Here, the thickness of the sealing portion 30 is preferably, for example, about 5 μm or more and about 50 μm or less, and the size thereof is preferably such that it covers the entire or substantially the entire first main surface 10a of the insulating substrate 10, for example.

The outer surface 30a of the sealing portion 30 is provided with a second through hole 12. The second through hole 12 extends from the outer surface 30a to an upper surface 18a of the lead-out electrode 18 through the sealing portion 30. The second through hole 12 is filled with the second via conductor 14. The second via conductor 14 has, for example, a cylindrical or substantially cylindrical shape.

The second via conductor 14 defines a portion of the above-described second external connection wiring line. The second via conductor 14 is disposed within a region where the capacitance generating portion 20 is disposed, when viewed in the normal direction of the first main surface 10a of the insulating substrate 10.

The second via conductor 14 can be made of any of various wiring materials, but is particularly preferably made of a metal material having high electrical conductivity. The second via conductor 14 can be made of, for example, a metal material mainly including any one of Ni, Ag, Cu, Au, Pt, Mo, or W. The material of the second via conductor 14 can be changed as appropriate in accordance with the environment in which the capacitor 1A according to the present example embodiment is mounted. In the present example embodiment, the second via conductor 14 is made of Ni, for example.

The axial length and size of the second via conductor 14 are not particularly limited, and are set as appropriate in accordance with the thickness and size of the sealing portion 30. Here, the second via conductor 14 preferably has an axial length of, for example, about 5 μm or more and about 75 μm or less, and a diameter of, for example, about 15 μm or more and about 150 μm or less. In the present example embodiment, for example, the second via conductor 14 is made of Ni and has an axial length of about 75 μm and a diameter of about 150 μm.

On the outer surface 30a of the sealing portion 30, the second bump 17 is disposed so as to cover the second via conductor 14. The second bump 17 defines and functions as a bonding member to mount the capacitor 1A on a wiring board or the like and to electrically connect the capacitance generating portion 20 of the capacitor 1A to an external circuit. The second bump 17 is disposed so as to protrude from the outer surface 30a of the sealing portion 30. The second bump 17 has a hemispherical or substantially hemispherical shape. The second bump 17 defines a portion of the above-described second external connection wiring line.

The second bump 17 can be made of any of various wiring materials, but is particularly preferably made of a metal material having high electrical conductivity. The second bump 17 can be made of, for example, a metal material mainly including any one of Ni, Ag, Cu, Au, or Sn. In the present example embodiment, the second bump 17 is made of Au, for example.

The size of the second bump 17 is not particularly limited, and is set as appropriate in accordance with the size of the second via conductor 14.

According to the above, the second external connection wiring line defining and functioning as a cathode of the pair of external connection wiring lines includes the lead-out electrode 18, the second via conductor 14, and the second bump 17. The second external connection wiring line having such a configuration is located inward relative to the outer edge portion of the capacitance generating portion 20 in the direction parallel or substantially parallel to the first main surface 10a of the insulating substrate 10. This makes it possible to increase the reliability of the capacitor 1A that has been mounted, the details of which will be described below.

With the above-described configuration, in the capacitor 1A according to the present example embodiment, the capacitance generating portion 20 including the conductive structure 21, the first dielectric film 22a, and the conductive film 23 is sealed by the insulating substrate 10 and the sealing portion 30, and electrical lead-out of the capacitance generating portion 20 is defined by the pair of external connection wiring lines.

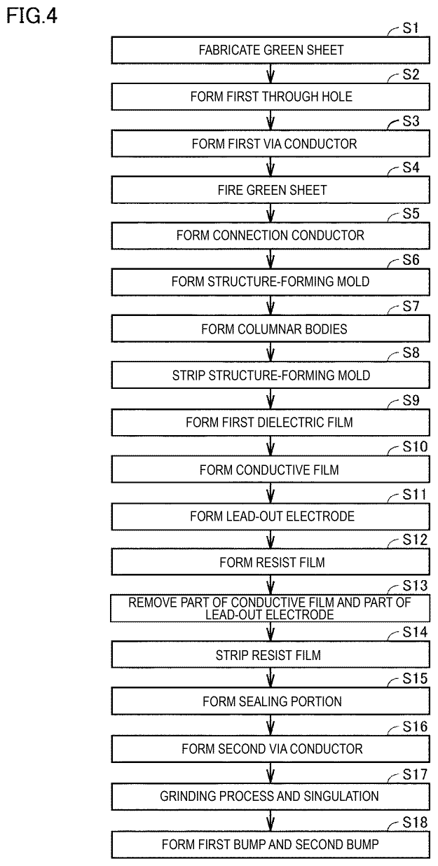

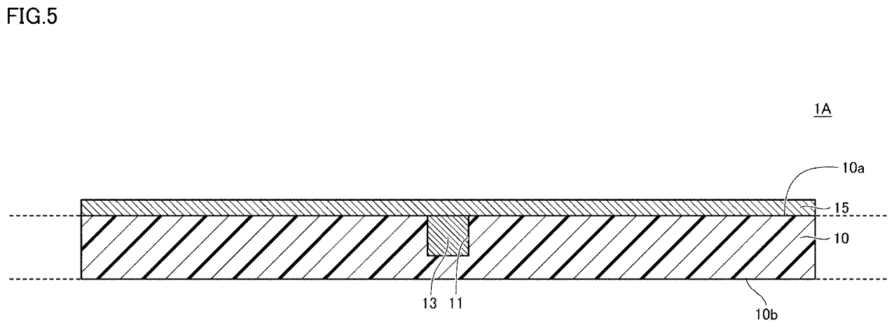

FIG. 4 is a flowchart illustrating a method of manufacturing a capacitor according to the present example embodiment. FIG. 5 to FIG. 16 are schematic sectional views for describing the individual steps of the manufacturing flow illustrated in FIG. 4. Now, an example of a specific manufacturing method for manufacturing the above-described capacitor 1A according to the present example embodiment will be described with reference to FIG. 4 to FIG. 16.

The method of manufacturing the capacitor 1A described below is a method in which an assembly of in-process capacitors is fabricated by performing collective processing up to a mid-stage of a manufacturing process, the assembly is then divided into individual pieces, the individual pieces are further processed, and thus a plurality of capacitors 1A are simultaneously mass-produced.

First, as illustrated in FIG. 4, in step S1, a green sheet is fabricated. Specifically, Al₂O₃ powder and glass powder are weighed, and these Al₂O₃ powder and glass powder are mixed with an organic solvent such as toluene or ethanol, and a binder such as polyvinyl butyral. This mixture is then formed into a sheet, and thus a green sheet defining and functioning as an insulating substrate is fabricated. After the green sheet has been fabricated, the green sheet is cut into a plurality of green sheets.

Next, as illustrated in FIG. 4, in step S2, a first through hole is formed in a portion of the plurality of green sheets. Specifically, the first through hole 11, which will later be filled with a first via conductor defining and functioning as a portion of an anode, is provided at a predetermined position in the green sheet.

Here, the method of forming the first through hole 11 is not particularly limited. For example, the first through hole 11 can be formed by irradiating the green sheet with laser light. Alternatively, for example, the first through hole 11 may be formed by processing using a mechanical puncher or by sandblasting.

Next, as illustrated in FIG. 4, in step S3, the first via conductor is formed in the green sheet in which the first through hole has been formed. Specifically, a conductive paste is applied to the green sheet so as to fill the first through hole 11.

Here, the method of applying the conductive paste is not particularly limited. For example, a screen printing method can be used.

Next, as illustrated in FIG. 4, in step S4, the green sheet is fired. Specifically, a green sheet including no first through hole is superimposed on the green sheet to which the conductive paste is applied in step S3, and these green sheets superimposed one on another are pressure-bonded. The multilayer body of the pressure-bonded green sheets is then subjected to degreasing, and thereafter the degreased multilayer body of the green sheets is fired.

Here, in the case of laminating the green sheets, the green sheet without the first through hole 11 is laminated on the other main surface opposed to the one main surface of the green sheet having a conductive paste applied thereto. In the case of pressure-bonding the green sheets, a uniaxial press can be used, for example. Furthermore, the green sheets are fired, for example, in an air atmosphere under temperature conditions of about 700° C. to about 1000° C.

Through the above-described steps S1 to S4, an insulating substrate as illustrated in FIG. 5, which will be described below, is obtained. Here, the insulating substrate is a multi-substrate in which insulating substrates, each to be ultimately included in a corresponding one of a plurality of capacitors, are connected in a matrix arrangement. In FIG. 5, attention is focused only on one insulating substrate 10 among the insulating substrates, and the surrounding portions are omitted and indicated by broken lines.

Although the above description has been provided using an example in which a green sheet and a conductive paste are fired simultaneously, the first via conductor 13 may be provided after the insulating substrate including no through hole or the like has been fired. In this case, the first through hole 11 may be provided in the fired insulating substrate by, for example, sandblasting, wet etching, dry etching, or the like, and thereafter a conductive paste may be applied and fired. Alternatively, the first via conductor 13 may be formed by, for example, sputtering, vapor deposition, plating, or the like.

Next, as illustrated in FIG. 4 and FIG. 5, in step S5, a connection conductor is formed so as to cover one of a pair of main surfaces of the insulating substrate. More specifically, a conductive paste is applied onto the first main surface 10a, which is the one main surface of the insulating substrate 10.

Here, the method of applying the conductive paste is not particularly limited. For example, a screen printing method can be used.

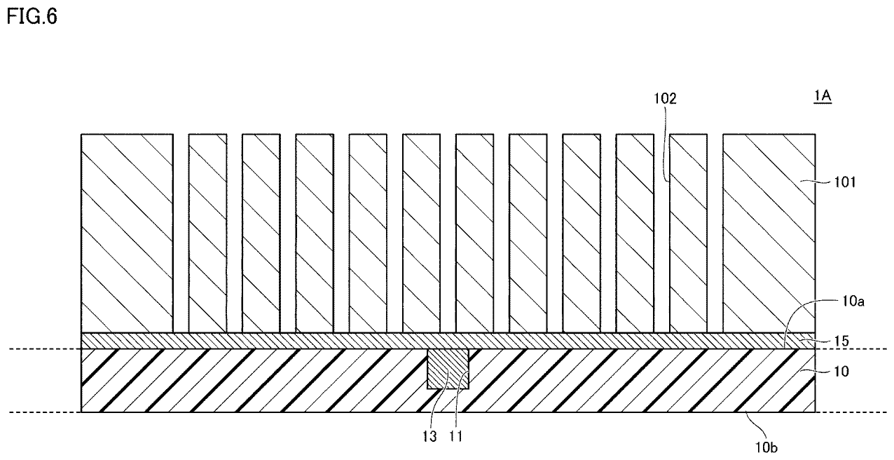

Next, as illustrated in FIG. 4 and FIG. 6, in step S6, a structure-forming mold used to form a structure is formed. Specifically, a structure-forming mold 101 is formed on, of a pair of main surfaces of the connection conductor 15, the main surface located opposite to the insulating substrate 10 as viewed from the connection conductor 15.

The structure-forming mold 101 is formed through the following procedure, for example. First, a photosensitive resin is irradiated with X-rays through an X-ray mask. Next, the photosensitive resin irradiated with X-rays is developed. As a result, only the portion exposed to X-rays of the photosensitive resin selectively remains, thus forming a microstructure. The photosensitive resin used here is not limited to a negative photosensitive resin in which the portion exposed to X-rays selectively remains as described above, but may be a positive photosensitive resin in which the portion exposed to X-rays selectively dissolves.

The microstructure formed in the above-described manner has a rectangular or substantially rectangular parallelepiped shape as a whole. The microstructure includes a plurality of pores 102 extending through the microstructure from one of the pair of main surfaces thereof to the other. The pores 102 have a uniform diameter of microns. This microstructure defines the structure-forming mold 101.

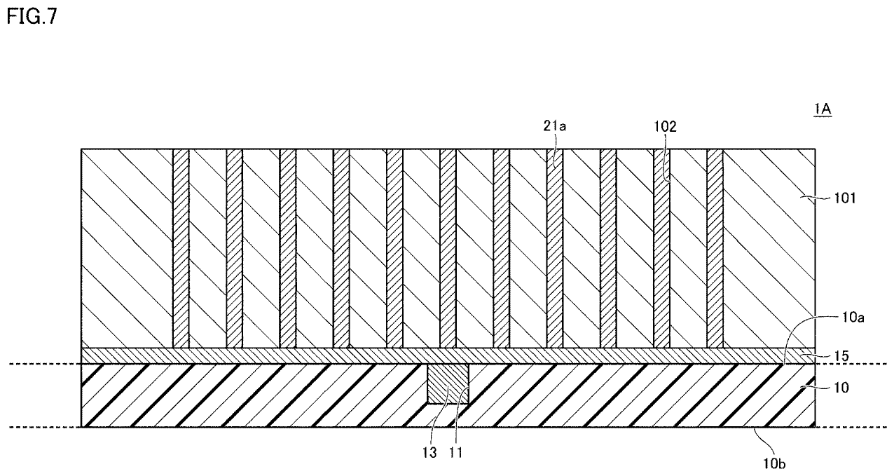

Next, as illustrated in FIG. 4 and FIG. 7, in step S7, a plurality of conductive columnar bodies are formed. More specifically, the columnar bodies 21a are formed so as to fill the plurality of pores 102 provided in the structure-forming mold 101. The formed columnar bodies 21a are joined to the connection conductor 15 at their lower portions. The columnar bodies 21a can be formed by, for example, electrolytic plating.

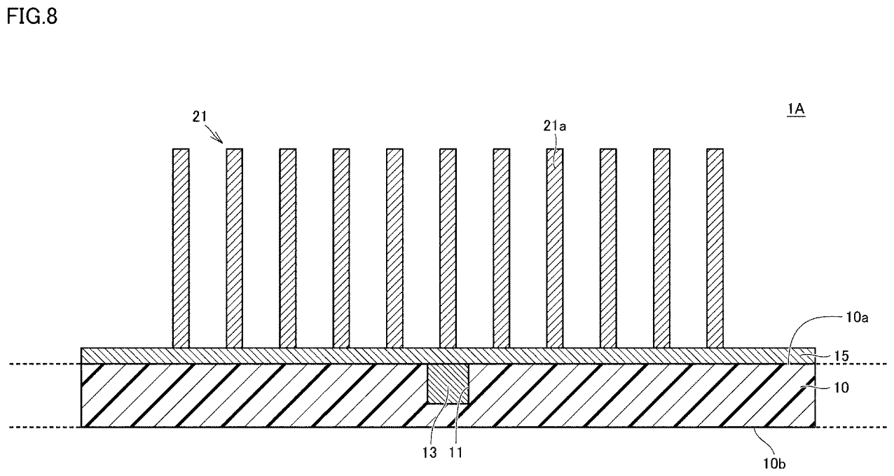

Next, as illustrated in FIG. 4 and FIG. 8, in step S8, the structure-forming mold is stripped. In this way, as a result of performing electrolytic plating on the mold and performing electroforming of stripping the mold from the electrodeposit formed thereby, the structure 21 having an overall uneven shape formed of the plurality of columnar bodies 21a is provided so as to be exposed on the first main surface 10a of the insulating substrate 10.

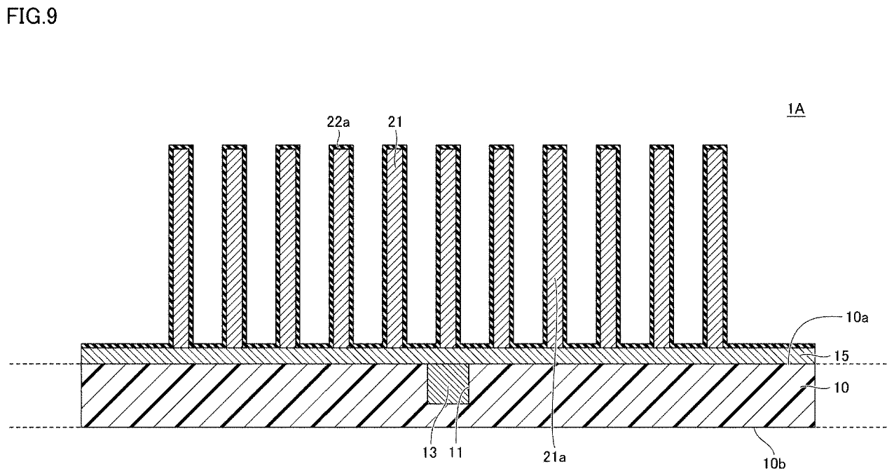

Next, as illustrated in FIG. 4 and FIG. 9, in step S9, a first dielectric film is formed. Specifically, the first dielectric film 22a is formed so as to cover the surfaces of the connection conductor 15 and the structure 21.

The method for forming the first dielectric film 22a is not particularly limited. Preferably, for example, ALD is used. Use of ALD makes it possible to supply the raw material of the first dielectric film 22a in the form of gas, which makes it possible to select the material and adjust the film thickness at an atomic layer level.

In the case of forming the first dielectric film 22a using ALD, it is preferable to use a source gas with high thermal stability and further with high reactivity, in addition to having a high vapor pressure and being easily gasified. From this viewpoint, in the case of forming an AlOₓ film, for example, it is preferable to use trimethylaluminum (TMA) as a raw material, and in the case of forming an SiOₓ film, it is preferable to use tris(dimethylamino)silane (TDMAS) as a raw material. In the present example embodiment, for example, the first dielectric film 22a is formed using ALD.

The first dielectric film 22a is formed under temperature conditions of, for example, about 150° C. or higher and about 400° C. or lower, although the conditions vary depending on the film formation method and film formation material.

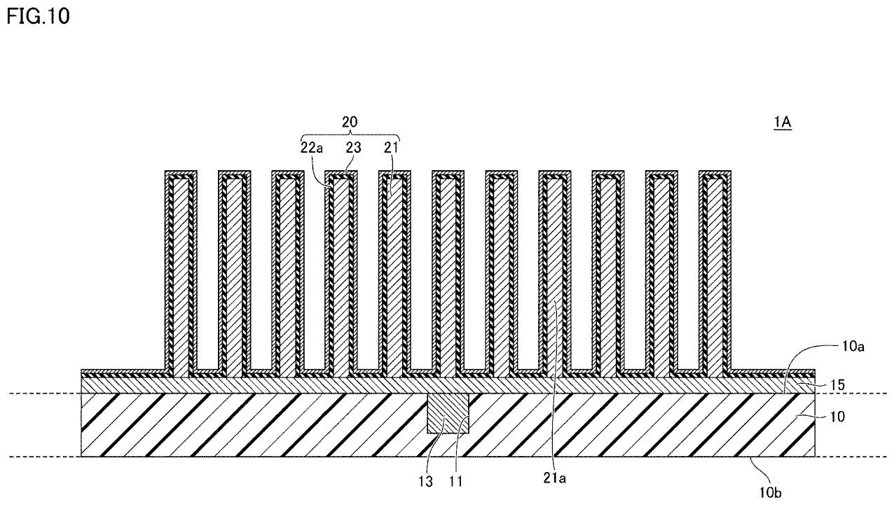

Next, as illustrated in FIG. 4 and FIG. 10, in step S10, a conductive film is formed. More specifically, the conductive film 23 is formed so as to cover the first dielectric film 22a formed in step S9.

The method of forming the conductive film 23 is not particularly limited. Preferably, for example, ALD is used. Use of ALD makes it possible to supply the raw material of the conductive film 23 in the form of gas, which makes it possible to select the material and adjust the film thickness at an atomic layer level. The conductive film 23 is formed under temperature conditions of, for example, about 150° C. or higher and about 600° C. or lower, although the conditions vary depending on the film formation method and film formation material.

Through the above-described steps S7 to S10, as illustrated in FIG. 10, the capacitance generating portion 20 including the conductive structure 21, the first dielectric film 22a, and the conductive film 23 and including an uneven outermost surface is formed on the first main surface 10a of the insulating substrate 10.

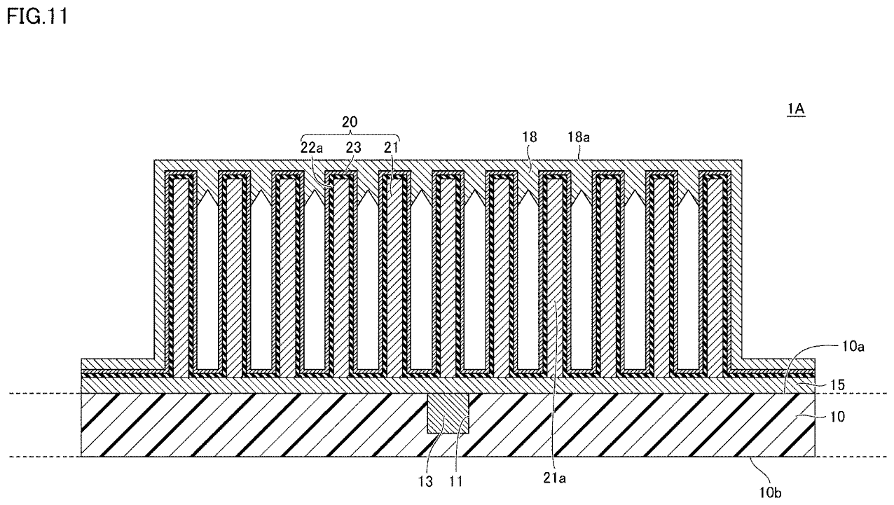

Next, as illustrated in FIG. 4 and FIG. 11, in step S11, a lead-out electrode is formed. More specifically, the lead-out electrode 18 is formed so as to cover the surface of a portion of the conductive film 23 formed in step S10 other than a portion defining the bottom surface side of recessed portions of the capacitance generating portion 20.

The method of forming the lead-out electrode 18 is not particularly limited. Preferably, for example, sputtering is used. Use of sputtering makes it possible to reduce the time required to form the lead-out electrode 18, as compared with other forming methods.

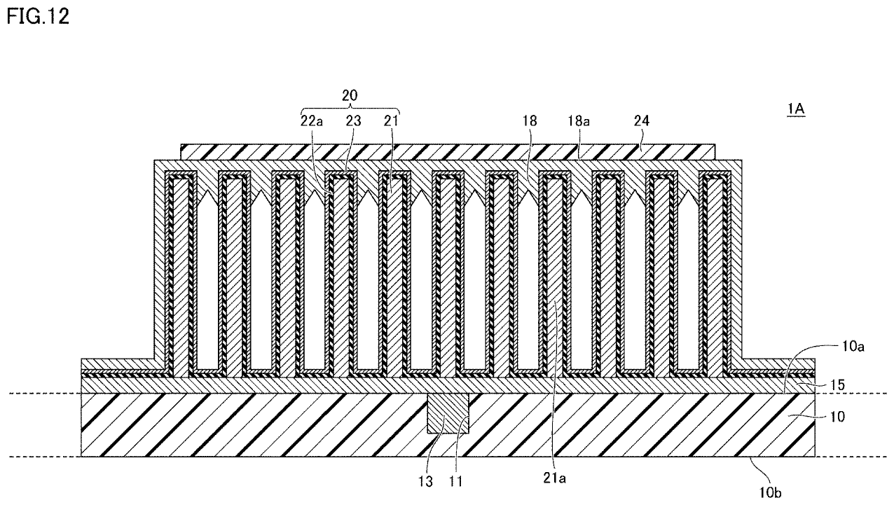

Next, as illustrated in FIG. 4 and FIG. 12, in step S12, a resist film is formed. More specifically, a resist film 24 is formed so as to cover a portion of the lead-out electrode 18, the portion covering a portion of the conductive film 23 other than a portion defining the outer edge portion of the capacitance generating portion 20 in the direction parallel or substantially parallel to the first main surface 10a of the insulating substrate 10 (i.e., both end portions in the right-left direction in FIG. 12).

Here, the method of forming the resist film 24 is not particularly limited. In the present example embodiment, for example, a photosensitive liquid resist is uniformly applied to a predetermined surface of the lead-out electrode 18 by spin coating, and the resist is locally exposed to light by using a photomask. Next, immersion in a developer solution removes an unnecessary portion of the photosensitive liquid resist, the remaining photosensitive liquid resist is dried in an oven or the like, and thereby the resist film 24 is formed.

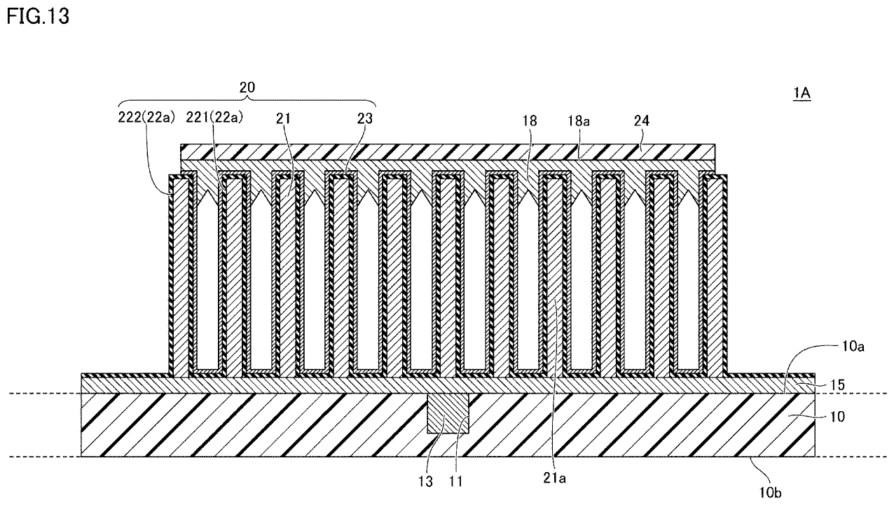

Next, as illustrated in FIG. 4 and FIG. 13, in step S13, a portion of the conductive film and a portion of the lead-out electrode are removed. More specifically, the portion of the lead-out electrode 18 not covered by the resist film 24 formed in step S12, and the corresponding portion of the conductive film 23 are removed. Examples of a removal method include wet etching, dry etching, and atomic layer etching (ALE).

As a result of the removal, the first dielectric film 22a includes the non-exposed portion 221 that is covered by the conductive film 23 and the exposed portion 222 that is not covered by the conductive film 23.

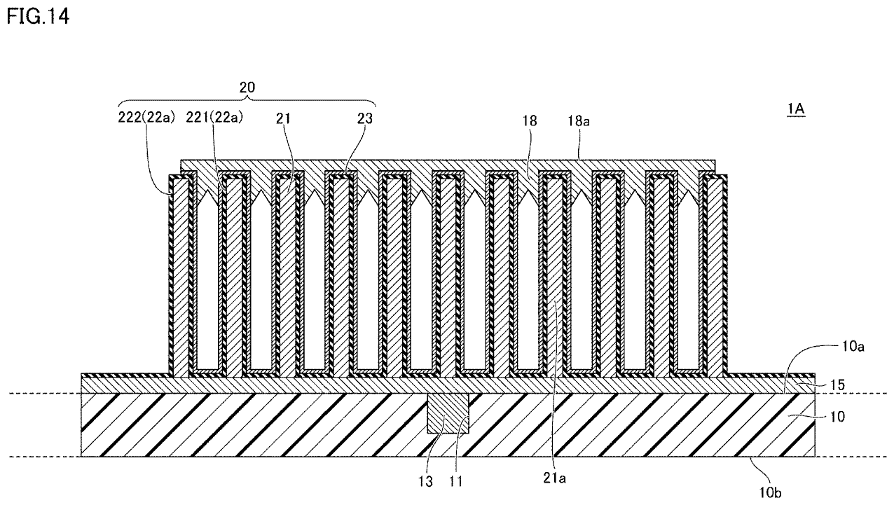

Next, as illustrated in FIG. 4 and FIG. 14, in step S14, the resist film is stripped and removed. More specifically, the resist film 24 is stripped by using a stripping solution or the like.

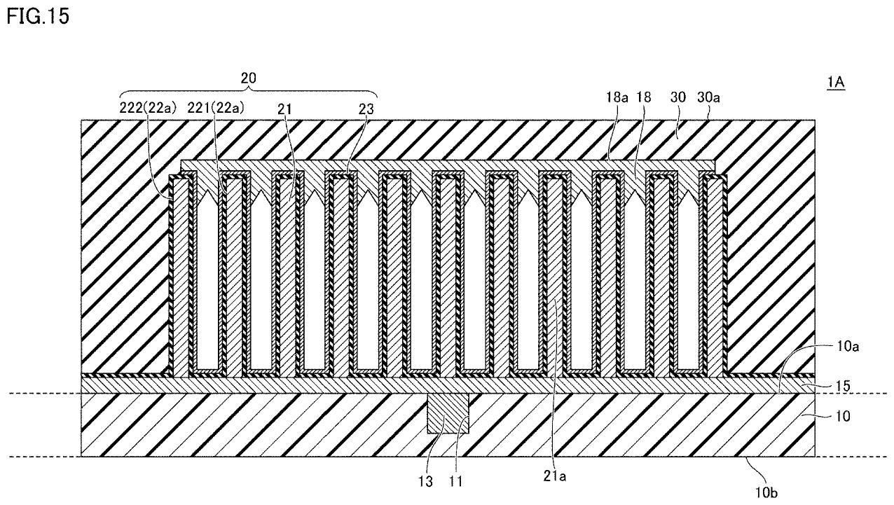

Next, as illustrated in FIG. 4 and FIG. 15, in step S15, a sealing portion is formed. More specifically, the sealing portion 30 is provided on the first main surface 10a of the insulating substrate 10 provided with the capacitance generating portion 20, so as to cover the capacitance generating portion 20 and the lead-out electrode 18.

The sealing portion 30 is formed by, for example, compression molding. More specifically, a resin sheet is placed on the first main surface 10a of the insulating substrate 10, and in this state, a vacuum laminator is used to draw a vacuum, so that the resin sheet comes into close contact with the first main surface 10a of the insulating substrate 10. In this state, the resin sheet is heated to, for example, about 50° C. to about 100° C. to laminate the capacitance generating portion 20, and then further heated to, for example, about 100° C. to about 200° C. to perform full curing, and thus the sealing portion 30 is formed. The method of forming the sealing portion 30 is not limited to the above-described compression molding, but may be transfer molding, for example.

This results in the capacitance generating portion 20 and the lead-out electrode 18 being sealed by the insulating substrate 10 and the sealing portion 30, to prevent ingress of moisture into the capacitance generating portion 20 and the lead-out electrode 18 from the outside and ensure moisture resistance. Furthermore, the capacitance generating portion 20 is covered by the sealing portion 30, and thus the capacitance generating portion 20 is physically protected by the sealing portion 30. The curing conditions described above are merely examples and can be changed in various ways.

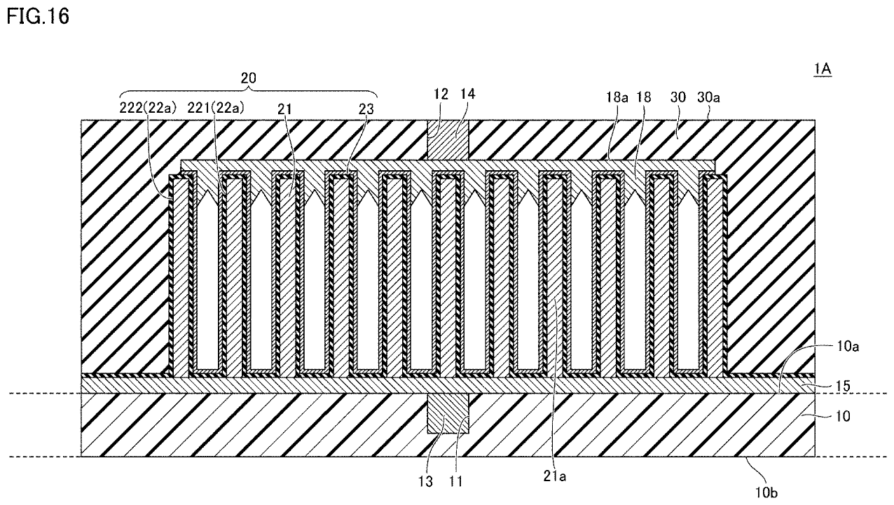

Next, as illustrated in FIG. 4 and FIG. 16, in step S16, a second via conductor is formed in the sealing portion.

More specifically, first, the second through hole 12 is formed in the sealing portion 30 so as to extend from the outer surface 30a to the upper surface 18a of the lead-out electrode 18. Next, the second via conductor 14 is formed so as to fill the second through hole 12.

The second via conductor 14 can be formed by, for example, electrolytic plating. In this case, the portion other than the second through hole 12 is covered with an ultraviolet-curable resin film defining and functioning as a mask (not illustrated), and electrolytic plating is performed in this state. Accordingly, only the inside of the second through hole 12 can be covered by a plating film. After the electrolytic plating is completed, the ultraviolet-curable resin film defining and functioning as a mask is removed.

The second via conductor 14 formed in this manner is joined to the lead-out electrode 18 at its end surface on the capacitance generating portion 20 side. Accordingly, the second via conductor 14 is connected to the capacitance generating portion 20 via the lead-out electrode 18.

Next, as illustrated in FIG. 4, in step S17, the insulating substrate is subjected to a grinding process and then singulation is performed.

More specifically, surface grinding is performed on the second main surface 10b of the insulating substrate 10, which is located opposite to the sealing portion 30 side, and then the insulating substrate 10 is separated, so that a plurality of capacitors 1A connected to each other are singulated.

Here, in the case of performing a grinding process, a grinding tape (not illustrated) is attached to the sealing portion 30 side, and the portion of the insulating substrate 10 that blocks the first via conductor 13 is removed by surface grinding. As a result, the end portion of the first via conductor 13 is exposed on the second main surface 10b side.

In the case of performing singulation, a groove is formed in the insulating substrate 10, and force is applied to the insulating substrate 10 so as to bend it starting from the groove, thus breaking the insulating substrate 10. The groove can be formed by, for example, diamond scribing, laser scribing, dicing, or the like. Alternatively, for example, the insulating substrate 10 and the sealing portion 30 may be directly cut by scribing or dicing to perform singulation.

Next, as illustrated in FIG. 4, in step S18, a first bump is formed on the insulating substrate, and a second bump is formed on the sealing portion. More specifically, as illustrated in FIG. 2, the first bump 16 is formed on the second main surface 10b of insulating substrate 10 so as to cover the first via conductor 13 provided in the insulating substrate 10. In addition, the second bump 17 is formed on the outer surface 30a of the sealing portion 30 so as to cover the second via conductor 14 provided in the sealing portion 30.

The first bump 16 can be formed by, for example, electrolytic plating. In this case, the portion other than the vicinity of the exposed portion of the first via conductor 13 is covered with an ultraviolet-curable resin film defining and functioning as a mask (not illustrated), and electrolytic plating is performed in this state. Accordingly, the first bump 16 protruding from the second main surface 10b can be formed. After the electrolytic plating is completed, the ultraviolet-curable resin film defining and functioning as a mask is removed. The same applies to the formation of the second bump 17.

The method of forming the second via conductor 14, the first bump 16, and the second bump 17 described above is not limited to the method using electrolytic plating described above. For example, it is also possible to use a combination of firing and a screen printing method using a conductive paste, an inkjet method, a dispenser method, or the like. In this case, it is preferable that the conductive paste includes a metal or sintering aid that can be fired at a low temperature so that firing can be performed under temperature conditions that do not affect the resin defining the sealing portion 30.

Through the above-described steps S1 to S18, the above-described capacitor 1A according to the first example embodiment is manufactured.

Here, in a capacitor including the capacitance generating portion 20 including an uneven outermost surface, such as the capacitor 1A according to the present example embodiment, cracks or other breakage may occur at the outer edge portion of the capacitance generating portion 20 in the direction parallel or substantially parallel to the first main surface 10a of the insulating substrate 10. Thus, if the capacitor 1A is configured such that electrical lead-out of the capacitance generating portion 20 is frequently performed from the outer edge portion, a short circuit may occur at a damaged portion, resulting in loss of functionality of the capacitor 1A.

In this regard, in the capacitor 1A according to the present example embodiment a portion of the first dielectric film 22a defining and functioning as a dielectric film other than a portion defining the outer edge portion defines the non-exposed portion 221 whose surface is covered by the conductive film 23, as described above. In addition the portion of the first dielectric film 22a defining the outer edge portion defines the exposed portion 222 whose surface is not covered by the conductive film 23.

Accordingly, of the surface of the capacitance generating portion 20, the portion other than the outer edge portion has an insulator metal (MIM) structure, whereas the outer edge portion has a metal insulator (MI) structure.

With this configuration, it is possible to reduce or prevent electrical lead-out of the capacitance generating portion 20 from the outer edge portion where breakage is likely to occur as described above, while allowing electrical lead-out from other portions. As a result, it is possible to obtain the capacitor 1A in which loss of functionality due to the above-described breakage is reduced or prevented and the reliability after mounting is increased.

Thus, with the capacitor 1A according to the present example embodiment, the reliability after mounting is increased in the capacitor including a capacitance generating portion that includes a conductive structure, a dielectric film, and a conductive film.

In the capacitor 1A according to the present example embodiment, the second external connection wiring line defined by the lead-out electrode 18 and so forth is located inward relative to the outer edge portion of the capacitance generating portion 20 in the direction parallel or substantially parallel to the first main surface 10a of the insulating substrate 10, as described above. Thus, the lead-out electrode 18 covers a portion of the surface of the conductive film 23 in the portion covering the non-exposed portion 221 and is electrically connected thereto, while being located so as not to cover the surface of the exposed portion 222.

With this configuration, it is possible to more reliably reduce or prevent electrical lead-out of the capacitance generating portion 20 from the outer edge portion where breakage is likely to occur as described above. This also makes it possible to provide the capacitor 1A having increased reliability after mounting.

Furthermore, in the capacitor 1A according to the present example embodiment, when viewed in the normal direction of the first main surface 10a of the insulating substrate 10, the first via conductor 13 and the second via conductor 14 are both disposed within a region where the capacitance generating portion 20 is disposed, as described above.

With this configuration, neither the first external connection wiring line nor the second external connection wiring line is located beside the capacitance generating portion 20, and thus the portion of the sealing portion 30 located beside the capacitance generating portion 20 can be minimized. Thus, the capacitor 1A can be made smaller than an existing capacitor. In addition, the volume occupied by the portion other than the capacitance generating portion 20 in the capacitor 1A can be reduced to achieve a higher capacitance.

Regarding the above-described capacitor 1A according to the present example embodiment, a description has been provided of a case where the lead-out electrode 18 covers the surface of a portion of the conductive film 23 other than a portion defining the bottom surface side of the recessed portion of the capacitance generating portion 20, in other words, a case where the lead-out electrode 18 does not cover the surface of the portion of the conductive film 23 defining the bottom surface side of the recessed portion of the capacitance generating portion 20. Alternatively, the lead-out electrode 18 may cover the surface of the portion of the conductive film 23 defining the bottom surface side of the recessed portion of the capacitance generating portion 20. In this case, the lead-out electrode 18 can be formed by, for example, CVD or ALD.

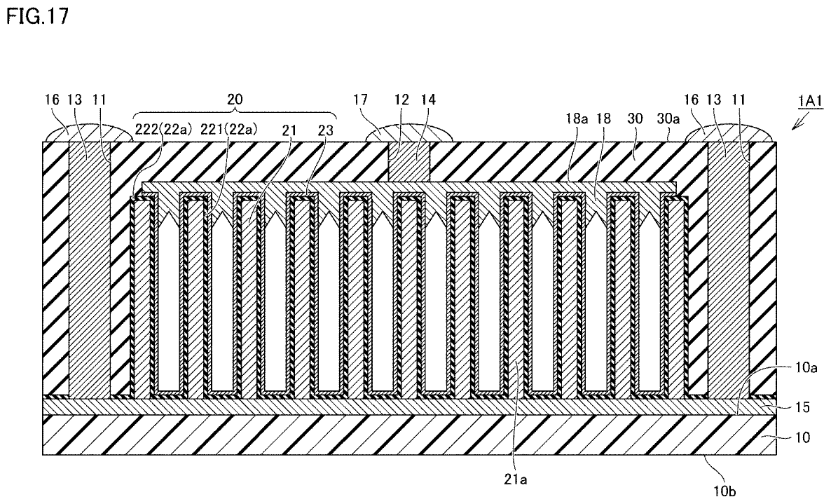

FIG. 17 is a schematic sectional view of a capacitor according to a first modification of an example embodiment of the present invention. Hereinafter, a capacitor 1A1 according to the first modification based on the above-described first example embodiment will be described with reference to FIG. 17.

As illustrated in FIG. 17, the capacitor 1A1 according to the first modification is different from the above-described capacitor 1A according to the first example embodiment in the configuration of the first external connection wiring line.

More specifically, in the capacitor 1A1 according to the present modification, electrical lead-out of the capacitance generating portion 20 through the first external connection wiring line is performed from the outer surface 30a side of the sealing portion 30, similar to the second external connection wiring line.

That is, in the present modification, the first through hole 11 is provided in the sealing portion 30 so as to extend from the outer surface 30a of the sealing portion 30 to the upper surface of the connection conductor 15. In addition, the first via conductor 13 is provided so as to fill the first through hole 11. Furthermore, the first bump 16 is provided on the outer surface 30a of the sealing portion 30 so as to cover the first via conductor 13 provided in the sealing portion 30.

Also in this configuration, advantageous effects the same as or similar to those described in the first example embodiment can be obtained, and the reliability after mounting can be increased in the capacitor including a capacitance generating portion that includes a conductive structure, a dielectric film, and a conductive film.

Furthermore, in this configuration, the first via conductor 13 and the second via conductor 14 are located so as to extend through the sealing portion 30 in its thickness direction, and thus these via conductors of different polarities are disposed close to each other such that their current paths are oriented in opposite directions. Thus, when currents flow through the via conductors, magnetic fields generated in the via conductors act to cancel each other out, and thus an equivalent series inductance (ESL) can be reduced.

The capacitor 1A1 according to the first modification can be manufactured by, for example, simultaneously forming the first through hole 11 and the second through hole 12 and simultaneously forming the first via conductor 13 and the second via conductor 14, with the remaining steps basically the same or substantially the same as those of the method of manufacturing the capacitor 1A according to the first example embodiment described above.

In the cross section of the capacitor 1A1 illustrated in FIG. 17, two first external connection wiring lines are located so as to sandwich the capacitance generating portion 20. However, the configuration of the first external connection wiring lines when the capacitor 1A1 is viewed in plan is not particularly limited thereto and can be changed as appropriate.

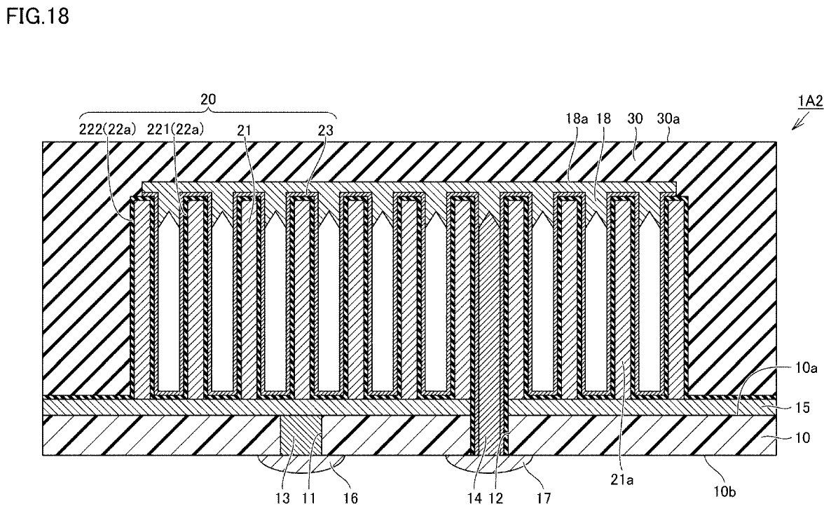

FIG. 18 is a schematic sectional view of a capacitor according to a second modification of an example embodiment of the present invention. Hereinafter, a capacitor 1A2 according to the second modification based on the above-described first example embodiment will be described with reference to FIG. 18.

As illustrated in FIG. 18, the capacitor 1A2 according to the second modification is different from the above-described capacitor 1A according to the first example embodiment in the configuration of the second external connection wiring line.

More specifically, in the capacitor 1A2 according to the present modification, electrical lead-out of the capacitance generating portion 20 through the second external connection wiring line is performed from the second main surface 10b side of the insulating substrate 10, like the first external connection wiring line.

That is, in the present modification, the second through hole 12 is provided in the insulating substrate 10, the connection conductor 15, and the capacitance generating portion 20 so as to extend from the second main surface 10b of the insulating substrate 10 to the lower surface of the lead-out electrode 18. In addition, the second via conductor 14 is provided so as to fill the second through hole 12. Accordingly, the second via conductor 14 is connected to the capacitance generating portion 20 via the lead-out electrode 18. Furthermore, the second bump 17 is provided on the second main surface 10b of the insulating substrate 10 so as to cover the second via conductor 14 disposed in the insulating substrate 10.

In the present modification, the first dielectric film 22a and the conductive film 23 cover not only the surface of the structure 21 but also the surface of a portion of the insulating substrate 10 and the connection conductor 15 defining the second through hole 12. More specifically, at a boundary portion between the second via conductor 14 and a base material of the insulating substrate 10, the base material of the insulating substrate 10 is covered by the first dielectric film 22a, the first dielectric film 22a is covered by the conductive film 23, and the conductive film 23 is covered by the second via conductor 14. Similarly, at a boundary portion between the lead-out electrode 18 and the connection conductor 15, the connection conductor 15 is covered by the first dielectric film 22a, the first dielectric film 22a is covered by the conductive film 23, and the conductive film 23 is covered by the lead-out electrode 18.

Also in this configuration, advantageous effects the same as or similar to those described in the foregoing first example embodiment can be obtained, and the reliability after mounting can be increased in the capacitor including a capacitance generating portion that includes a conductive structure, a dielectric film, and a conductive film.

Furthermore, in this configuration, the first via conductor 13 and the second via conductor 14 are located so as to extend through the insulating substrate 10 in its thickness direction, and thus these via conductors of different polarities are disposed close to each other such that their current paths are oriented in opposite directions. Thus, when currents flow through the via conductors, magnetic fields generated in the via conductors act to cancel each other out, and thus an ESL can be reduced.

The capacitor 1A2 according to the second modification can be manufactured by, for example, performing the formation of the above-described second through hole 12 between the formation of the structure-forming mold 101 and the formation of the first dielectric film 22a (i.e., between step S8 and step S9), and performing the formation of the above-described second via conductor 14 between the grinding process of the insulating substrate 10 and the formation of the second bump 17 (i.e., between step S17 and step S18), with the remaining steps basically the same as or similar to the method of manufacturing the capacitor 1A according to the first example embodiment described above.

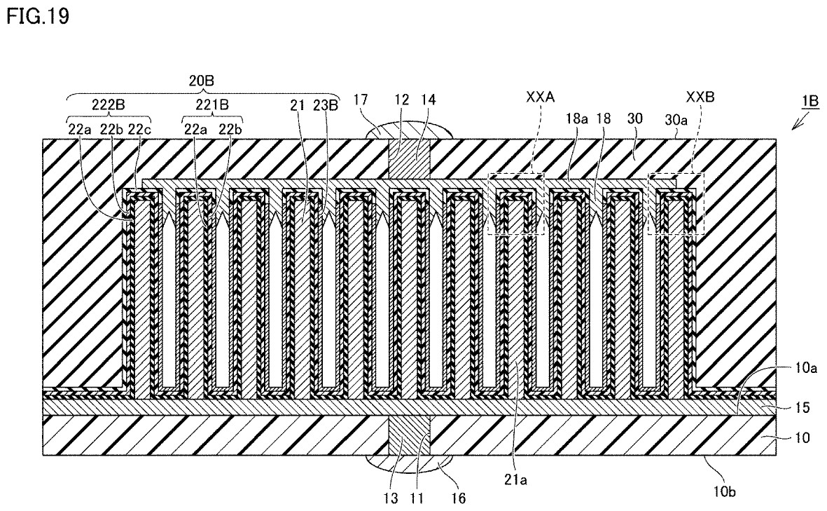

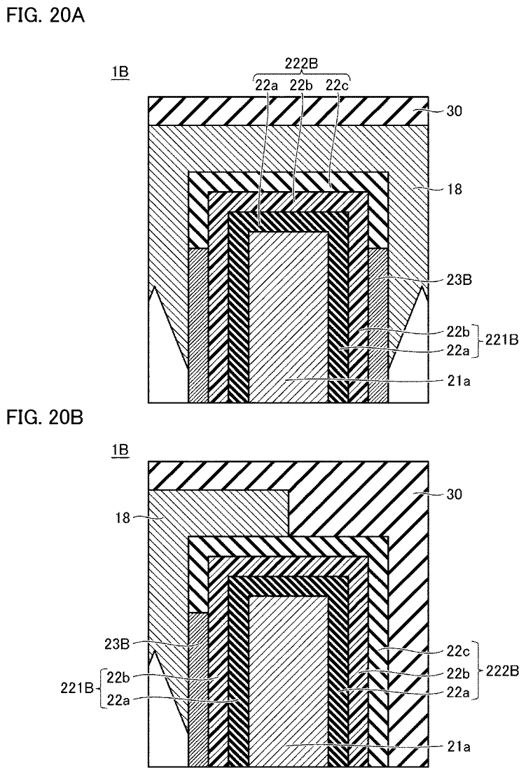

FIG. 19 is a schematic sectional view of a capacitor according to a second example embodiment of the present invention. FIGS. 20A and 20B are enlarged main-portion sectional views of region XXA and region XXB, respectively, of a capacitance generating portion illustrated in FIG. 19. Hereinafter, a capacitor 1B according to the present example embodiment will be described with reference to FIG. 19 and FIGS. 20A and 20B.

As illustrated in FIG. 19, the capacitor 1B according to the present example embodiment is different from the above-described capacitor 1A according to the first example embodiment in the configuration of a capacitance generating portion 20B.

The capacitance generating portion 20B includes the conductive structure 21, a dielectric film including the first dielectric film 22a, a second dielectric film 22b, and a third dielectric film 22c, and a conductive film 23B.

The first dielectric film 22a covers the surface of the structure 21, as described above. The second dielectric film 22b covers the entire or substantially the entire surface of the first dielectric film 22a. The third dielectric film 22c and the conductive film 23B each cover a portion of the surface of the second dielectric film 22b.

The second dielectric film 22b is an adhesive film that has adhesion to the conductive film 23B. The second dielectric film 22b may be made of an ionic material, and can be made of, for example, a metal oxide such as HfOₓ, TiOₓ, or YOₓ, or a metal nitride such as TiNₓ. Among them, it is preferable that the second dielectric film 22b is made of, for example, any one of HfO₂, Y₂O₃, TiO₂, or TiN. The above chemical formulas simply indicate the structure of the materials and do not limit the composition. That is, x attached to O and N may be any value greater than 0, and the abundance ratio of each element including a metal element is not specified. The second dielectric film 22b may include a laminated film including a plurality of dielectric layers made of different materials. In the present example embodiment, for example, the second dielectric film 22b is made of TiO₂.

The second dielectric film 22b can be preferably formed by a gas phase method, for example, vacuum deposition, CVD, sputtering, ALD, or PLD, or a method using a supercritical fluid, and is particularly preferably formed by ALD.

The thickness of the second dielectric film 22b is not particularly limited, but is, for example, preferably about 3 nm or more and about 100 nm or less, and more preferably about 5 nm or more and about 50 nm or less.

The third dielectric film 22c covers a portion of the surface of the second dielectric film 22b, as described above. More specifically, the third dielectric film 22c covers the surface of a portion of the second dielectric film 22b defining the outer edge portion in the direction parallel or substantially parallel to the first main surface 10a of the insulating substrate 10 (i.e., both end portions in the right-left direction in FIG. 19) and a portion corresponding to the tip end portions of the columnar bodies 21a. The third dielectric film 22c is a blocking film that does not have adhesion to the conductive film 23B.

The third dielectric film 22c can be made of, for example, a metal oxide such as AlOₓ or SiOₓ, or SiC. The above chemical formulas simply indicate the structure of the materials and do not limit the composition. That is, x attached to O may be any value greater than 0, and the abundance ratio of each element including a metal element is not specified. The third dielectric film 22c may include a laminated film including a plurality of dielectric layers made of different materials. In the present example embodiment, for example, the third dielectric film 22c is made of SiO₂.

The third dielectric film 22c can be preferably formed by a gas phase method, for example, vacuum deposition, CVD, sputtering, ALD, or PLD, or a method using a supercritical fluid, and is particularly preferably formed by ALD.

The thickness of the third dielectric film 22c is not particularly limited, but is, for example, preferably about 3 nm or more and about 100 nm or less, and more preferably about 5 nm or more and about 50 nm or less.

The conductive film 23B covers a portion of the surface of the second dielectric film 22b, as described above. Specifically, the conductive film 23B covers the surface of the portion of the second dielectric film 22b that is not covered by the third dielectric film 22c. The conductive film 23B selectively covers only the surface of the second dielectric film 22b. That is, the conductive film 23B has underlayer dependency with respect to the second dielectric film 22b. In the present example embodiment, for example, the conductive film 23B is made of Ru.

A film made of Ru and formed on an ionic material such as the above-described second dielectric film 22b has a shorter cycle until film formation (an incubation cycle) than a film made of Ru and formed on a non-ionic material. By utilizing a difference in incubation cycle resulting from a difference in underlayer, the conductive film 23B made of Ru has underlayer dependency with respect to the second dielectric film 22b made of an ionic material.

Accordingly, the dielectric film includes a non-exposed portion 221B that is covered by the conductive film 23B and an exposed portion 222B that is not covered by the conductive film 23B.

More specifically, as illustrated in FIG. 19 and FIG. 20A the portion of the second dielectric film 22b that is not covered by the third dielectric film 22c (i.e., of the second dielectric film 22b, a portion other than a portion defining the outer edge portion in the direction parallel or substantially parallel to the first main surface 10a of the insulating substrate 10 and a portion corresponding to the tip end portions of the columnar bodies 21a) has its surface covered by the conductive film 23B. Accordingly, the first dielectric film 22a and the second dielectric film 22b define the non-exposed portion 221B.

On the other hand, as illustrated in FIG. 19 and FIG. 20B, the portion of the second dielectric film 22b covered by the third dielectric film 22c (i.e., of the second dielectric film 22b, the portion defining the outer edge portion in the direction parallel or substantially parallel to the first main surface 10a of the insulating substrate 10 and the portion corresponding to the tip end portions of the columnar bodies 21a) has its surface not covered by the conductive film 23B. Accordingly, the first dielectric film 22a, the second dielectric film 22b, and the third dielectric film 22c define the exposed portion 222B.

In other words, at least the outer edge portion of the capacitance generating portion 20B in the direction parallel or substantially parallel to the first main surface 10a is defined by the exposed portion 222B including the first dielectric film 22a, the second dielectric film 22b, and the third dielectric film 22c. Thus, the outer edge portion of the surface of the capacitance generating portion 20B has an MI structure.

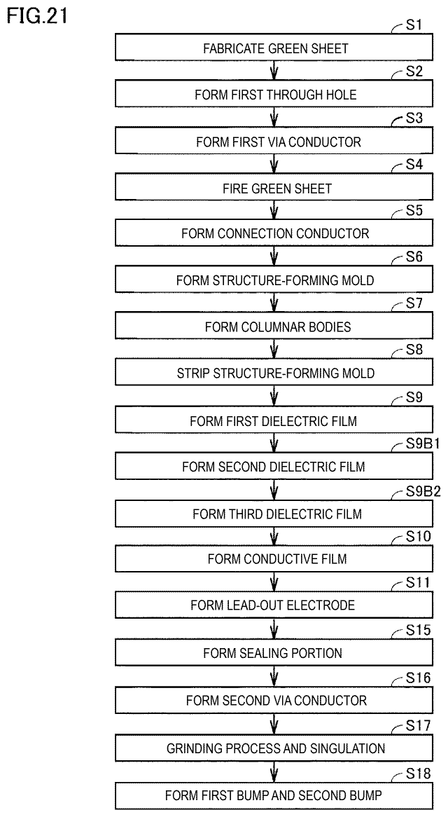

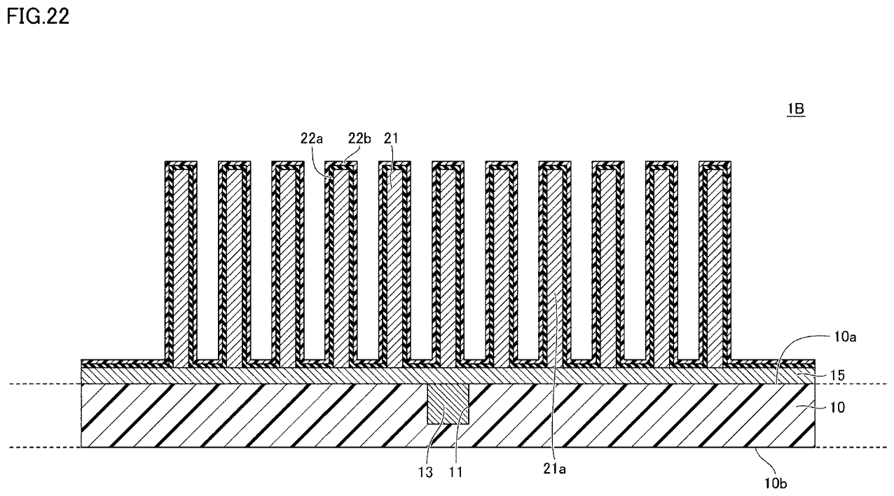

FIG. 21 is a flowchart illustrating a method of manufacturing a capacitor according to the present example embodiment. FIG. 22 to FIG. 24 are schematic sectional views for describing the individual steps of the manufacturing flow illustrated in FIG. 21. Now, an example of a specific manufacturing method for manufacturing the above-described capacitor 1B according to the present example embodiment will be described with reference to FIG. 21 to FIG. 24.

As illustrated in FIG. 21, the method of manufacturing the capacitor 1B mostly follows the method of manufacturing the capacitor 1A. Thus, the steps in the method of manufacturing the capacitor 1B that are the same or substantially the same as those in the method of manufacturing the capacitor 1A will not be described, and only the steps that are different from those in the method of manufacturing the capacitor 1A will be described.

As illustrated in FIG. 21 and FIG. 22, after a first dielectric film is formed in step S9, a second dielectric film is formed in step S9B1. More specifically, the second dielectric film 22b is formed so as to cover the entire or substantially the entire surface of the first dielectric film 22a.

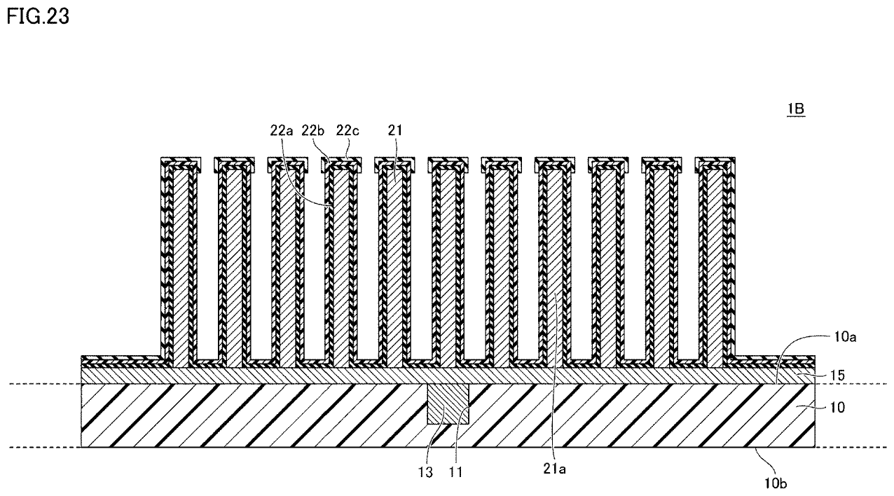

Next, as illustrated in FIG. 21 and FIG. 23, in step S9B2, a third dielectric film is formed. More specifically, the third dielectric film 22c is formed so as to cover the surface of a portion of the second dielectric film 22b defining the outer edge portion in the direction parallel or substantially parallel to the first main surface 10a of the insulating substrate 10 (i.e., both end portions in the right-left direction in FIG. 23) and a portion corresponding to the tip end portions of the columnar bodies 21a.

The method of forming the third dielectric film 22c and the above-described second dielectric film 22b is not particularly limited. Preferably, for example, ALD is used. Use of ALD makes it possible to supply the raw material of the second dielectric film 22b and the third dielectric film 22c in the form of gas, which makes it possible to select the material and adjust the film thickness at an atomic layer level.

In the case of forming the second dielectric film 22b using ALD, it is preferable to use a source gas with high thermal stability and further with high reactivity, in addition to having a high vapor pressure and being easily gasified.

The second dielectric film 22b and the third dielectric film 22c are formed under temperature conditions of, for example, about 150° C. or higher and about 400° C. or lower, although the conditions vary depending on the film formation method and film formation material.

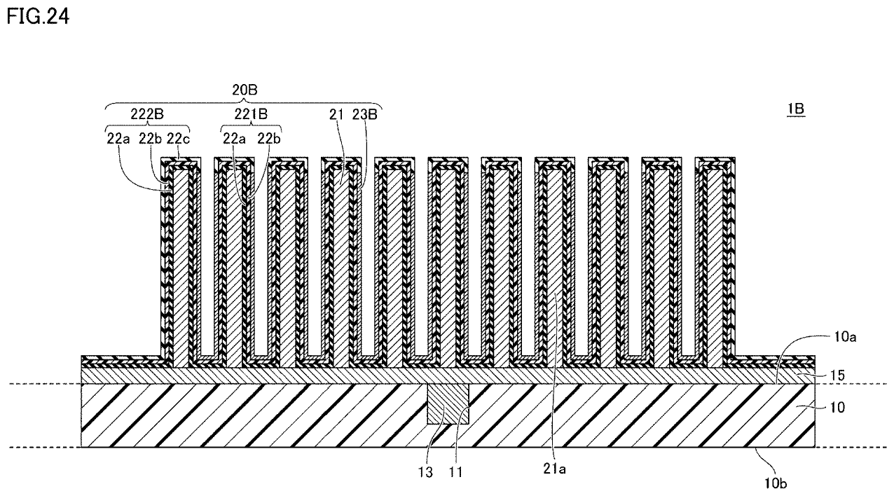

Next, as illustrated in FIG. 21 and FIG. 24, in step S10, a conductive film is formed. More specifically, the conductive film 23B is formed so as to cover the surface of the portion of the second dielectric film 22b formed in step S9B1 that is not covered by the third dielectric film 22c. This is because the second dielectric film 22b has adhesion to the conductive film 23B, the third dielectric film 22c does not have adhesion to the conductive film 23B, and the conductive film 23B has underlayer dependency with respect to the second dielectric film 22b.

Through the above-described steps S7 to S9 and the foregoing steps S9B1, S9B2, and S10, the capacitance generating portion 20B including the conductive structure 21, the first dielectric film 22a, the second dielectric film 22b, the third dielectric film 22c, and the conductive film 23B and including an uneven outermost surface is formed on the first main surface 10a of the insulating substrate 10, as illustrated in FIG. 19.

Through all of the steps S1 to S11, S15 to S18, S9B1, and S9B2 including the steps individually described above, the above-described capacitor 1B according to the second example embodiment is manufactured.

Also in the capacitor 1B according to the present example embodiment having this configuration, advantageous effects the same as or similar to those described in the foregoing first example embodiment can be obtained, and the reliability after mounting can be increased in the capacitor including a capacitance generating portion that includes a conductive structure, a dielectric film, and a conductive film.

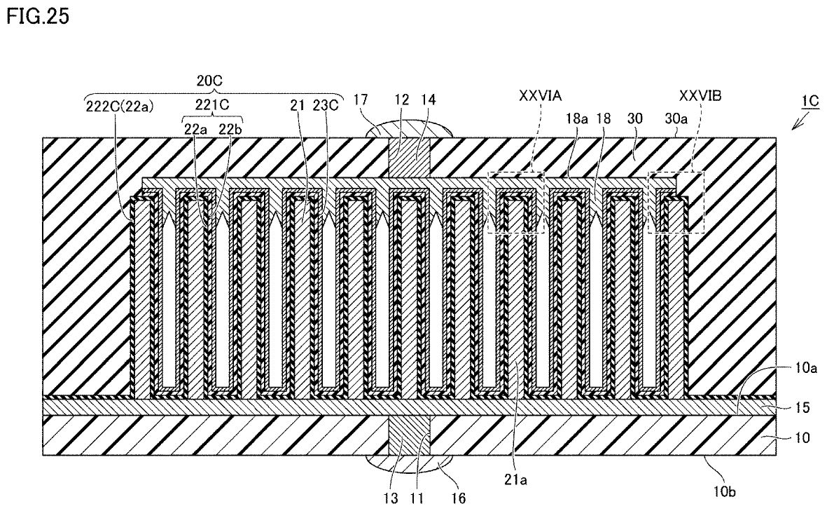

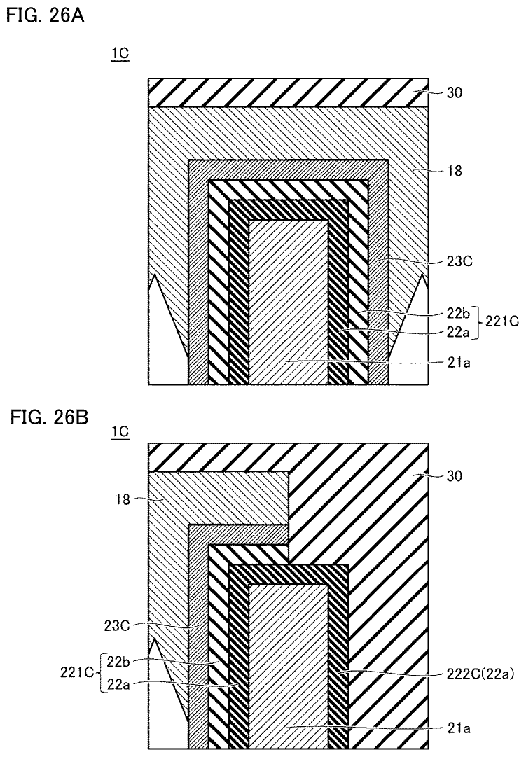

FIG. 25 is a schematic sectional view of a capacitor according to a third example embodiment of the present invention. FIGS. 26A and 26B are enlarged main-portion sectional views of region XXVIA and region XXVIB, respectively, of a capacitance generating portion illustrated in FIG. 25. Hereinafter, a capacitor 1C according to the present example embodiment will be described with reference to FIG. 25 and FIGS. 26A and 26B.

As illustrated in FIG. 25, the capacitor 1C according to the present example embodiment is different from the above-described capacitor 1A according to the first example embodiment in the configuration of a capacitance generating portion 20C.

The capacitance generating portion 20C includes the conductive structure 21, a dielectric film including the first dielectric film 22a and the second dielectric film 22b, and a conductive film 23C. The conductive film 23C has underlayer dependency with respect to the second dielectric film 22b, like the above-described conductive film 23B according to the second example embodiment.

The first dielectric film 22a covers the surface of the structure 21. The second dielectric film 22b covers a portion of the surface of the first dielectric film 22a. More specifically, the second dielectric film 22b covers the surface of a portion of the first dielectric film 22a other than a portion defining the outer edge portion in the direction parallel or substantially parallel to the first main surface 10a of the insulating substrate 10 (i.e., both end portions in the right-left direction in FIG. 25). The conductive film 23C covers the entire or substantially the entire surface of the second dielectric film 22b.

Accordingly, the dielectric film includes a non-exposed portion 221C that is covered by the conductive film 23C and an exposed portion 222C that is not covered by the conductive film 23C.

More specifically, as illustrated in FIG. 25 and FIG. 26A, the entire or substantially the entire surface of the second dielectric film 22b is covered by the conductive film 23C. Accordingly, the first dielectric film 22a and the second dielectric film 22b define the non-exposed portion 221C.

On the other hand, as illustrated in FIG. 25 and FIG. 26B the portion of the first dielectric film 22a covered by the second dielectric film 22b (i.e., of the first dielectric film 22a, the portion defining the outer edge portion in the direction parallel or substantially parallel to the first main surface 10a of the insulating substrate 10) has its surface not covered by the conductive film 23B. Accordingly, the first dielectric film 22a defines the exposed portion 222C.

In other words, the outer edge portion of the capacitance generating portion 20C in the direction parallel or substantially parallel to the first main surface 10a is defined by the exposed portion 222C defined by the first dielectric film 22a. Thus, the outer edge portion of the surface of the capacitance generating portion 20C has an MI structure.

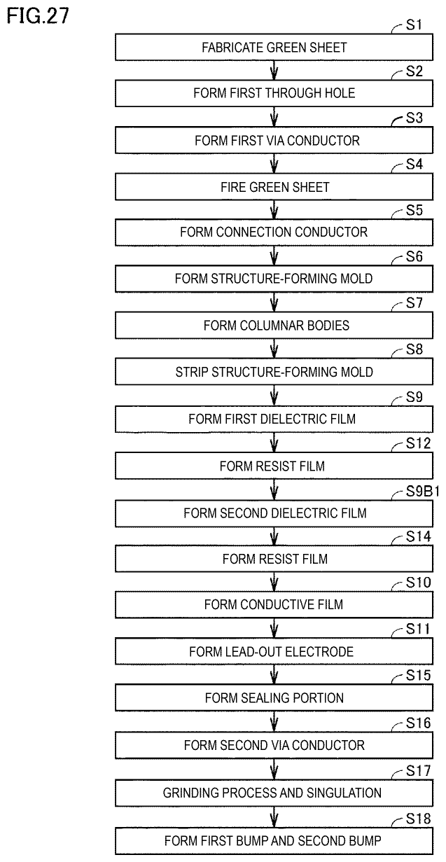

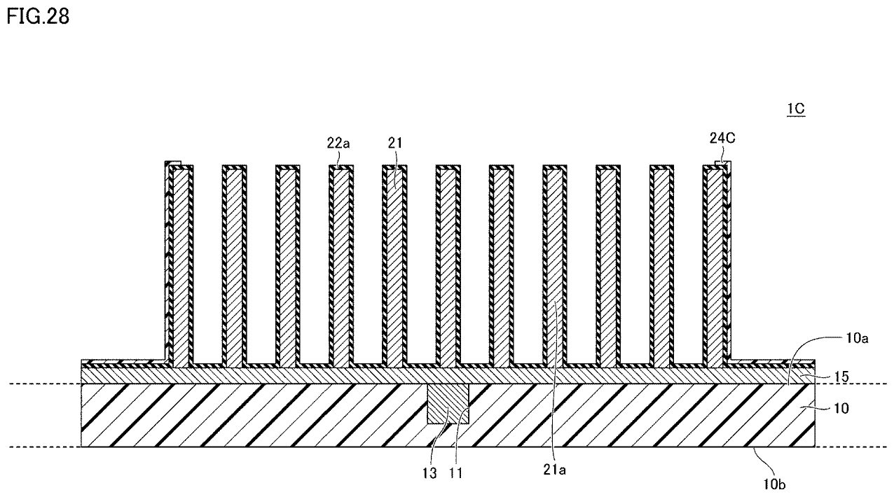

FIG. 27 is a flowchart illustrating a method of manufacturing a capacitor according to the present example embodiment. FIG. 28 to FIG. 31 are schematic sectional views for describing the individual steps of the manufacturing flow illustrated in FIG. 27. Now, an example of a specific manufacturing method for manufacturing the above-described capacitor 1C according to the present example embodiment will be described with reference to FIG. 27 to FIG. 31.

As illustrated in FIG. 27, the method of manufacturing the capacitor 1C mostly follows the method of manufacturing the capacitor 1A. Thus, the steps in the method of manufacturing the capacitor 1C that are the same or substantially the same as those in the method of manufacturing the capacitor 1A will not be described, and only the steps that are different from those in the method of manufacturing the capacitor 1A will be described.

As illustrated in FIG. 27 and FIG. 28, after a first dielectric film is formed in step S9, a resist film is formed in step S12. More specifically, a resist film 24 is formed so as to cover the surface of a portion of the first dielectric film 22a defining the outer edge portion in the direction parallel or substantially parallel to the first main surface 10a of the insulating substrate 10 (i.e., both end portions in the right-left direction in FIG. 28).

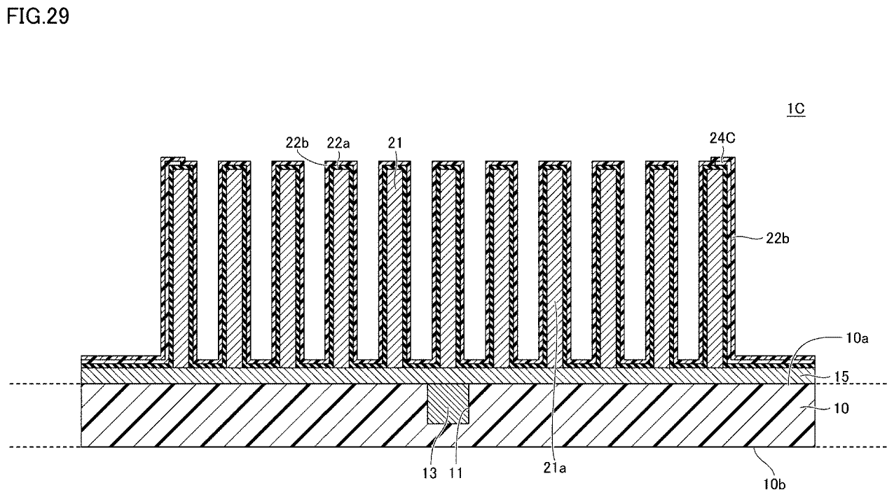

Next, as illustrated in FIG. 27 and FIG. 29, in step S9B1, a second dielectric film is formed. More specifically, the second dielectric film 22b is formed so as to cover the surface of the resist film 24 and the surface of the portion of the first dielectric film 22a that is not covered by the resist film 24C.

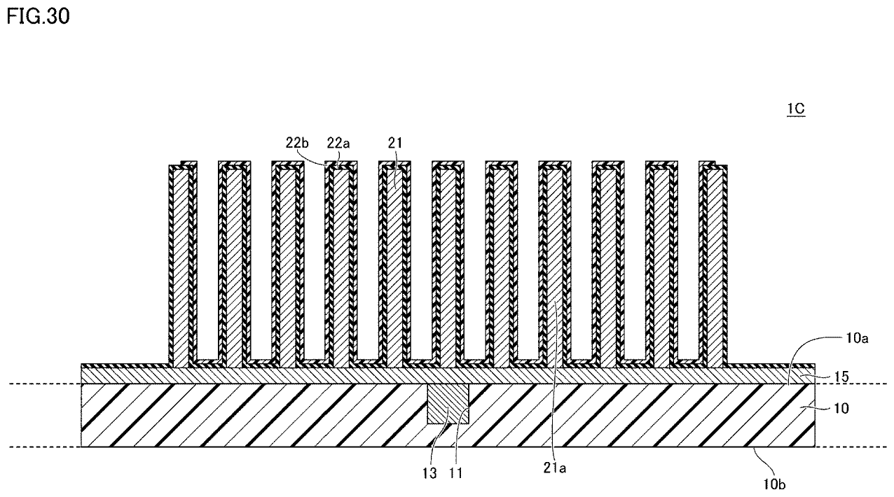

Next, as illustrated in FIG. 27 and FIG. 30, in step S14, the resist film is stripped off. More specifically, the resist film 24 is removed by being stripped off together with the portion of the second dielectric film 22b covering the surface thereof.

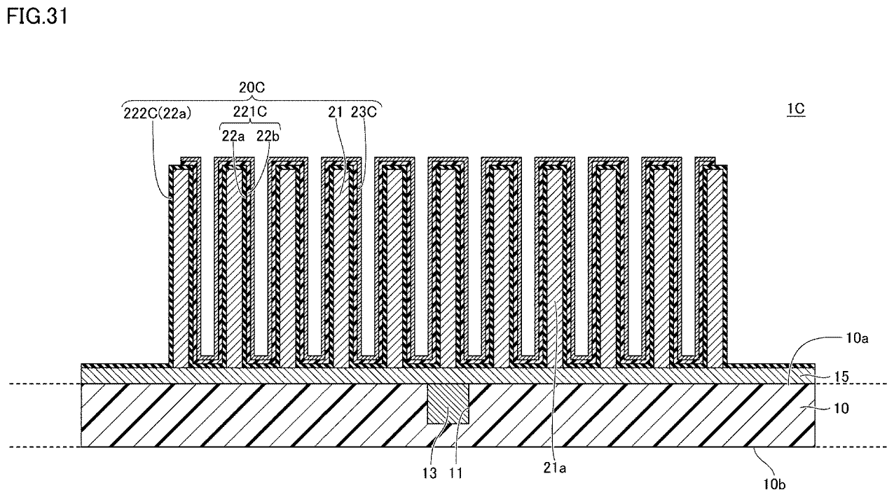

Next, as illustrated in FIG. 27 and FIG. 31, in step S10, a conductive film is formed. More specifically, the conductive film 23C is formed so as to cover the surface of the second dielectric film 22b remaining on the surface of the first dielectric film 22a after the resist film 24 is stripped in step S14. This is because the second dielectric film 22b has adhesion to the conductive film 23C, and the conductive film 23C has underlayer dependency with respect to the second dielectric film 22b.

Through the above-described steps S7 to S9 and the foregoing steps S12, S9B1, S14, and S10, the capacitance generating portion 20C including the conductive structure 21, the first dielectric film 22a, the second dielectric film 22b, and the conductive film 23C and including an uneven outermost surface is formed on the first main surface 10a of the insulating substrate 10, as illustrated in FIG. 25.

Through all of the steps S1 to S12, S14 to S18, and S9B1 including the steps individually described above, the above-described capacitor 1C according to the third example embodiment is manufactured.

Also in the capacitor 1C according to the present example embodiment having this configuration, advantageous effects the same as or similar to those described in the foregoing first example embodiment can be obtained, and the reliability after mounting can be increased in the capacitor including a capacitance generating portion that includes a conductive structure, a dielectric film, and a conductive film.

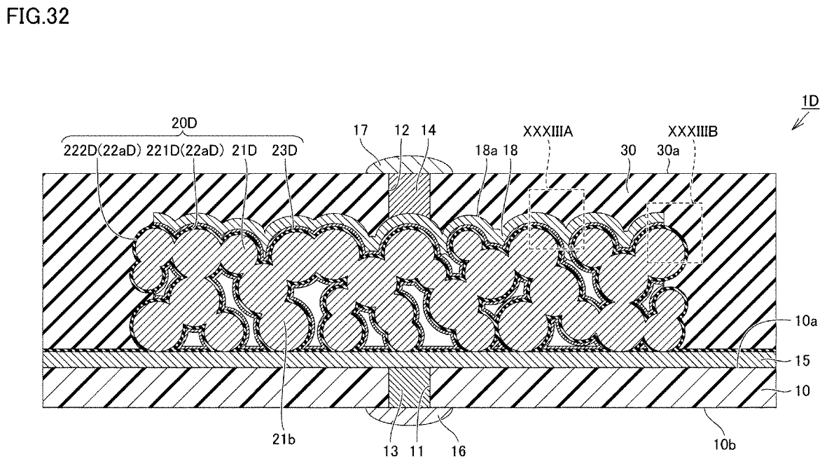

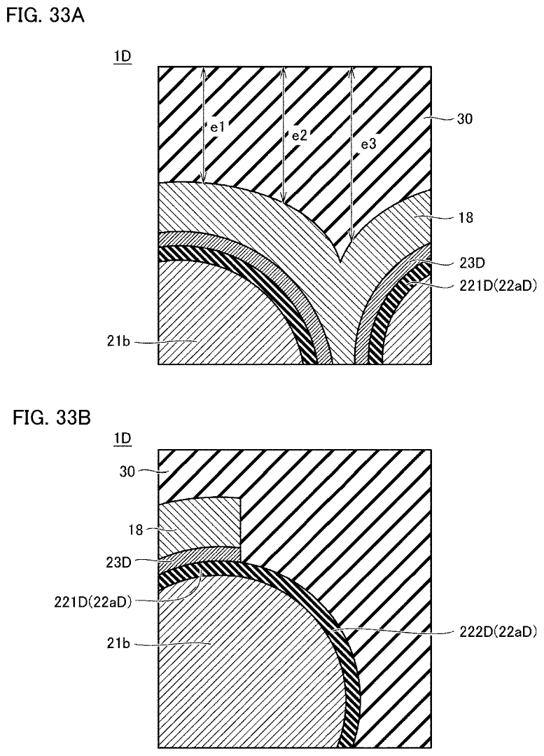

FIG. 32 is a schematic sectional view of a capacitor according to a fourth example embodiment of the present invention. FIGS. 33A and 33B are enlarged main-portion sectional views of region XXXIIIA and region XXXIIIB, respectively, of a capacitance generating portion illustrated in FIG. 32. Hereinafter, a capacitor 1D according to the present example embodiment will be described with reference to FIG. 32 and FIGS. 33A and 33B.

As illustrated in FIG. 32, the capacitor 1D according to the present example embodiment is different from the above-described capacitor 1A according to the first example embodiment in the configuration of a capacitance generating portion 20D.

The capacitance generating portion 20D includes a conductive structure 21D, a first dielectric film 22aD defining and functioning as a dielectric film, and a conductive film 23D.

The structure 21D is disposed on the first main surface 10a of the insulating substrate 10 with the connection conductor 15 interposed therebetween. The structure 21D is porous and includes a conductive porous metal body 21b including a plurality of fine pores therein.

At least some of the plurality of fine pores provided inside the porous metal body 21b are not closed by the porous metal body, and preferably most or all of the plurality of fine pores provided inside the porous metal body are not closed by the porous metal body. Such a porous metal body includes, for example, a sintered body of metal particles.

The porous metal body 21b is located on a portion of the first main surface 10a of the insulating substrate 10 other than the edge portion thereof. Accordingly, the porous metal body 21b is also located on the connection conductor 15 disposed on the first main surface 10a and is joined to the connection conductor 15. Thus, the above-described first external connection wiring line defining and functioning as an anode is connected to the capacitance generating portion 20D via the connection conductor 15.

The porous metal body 21b can be made of any of various conductive metal materials, but is preferably made of a metal material mainly including, for example, any one of Ni, Mo, W, Al, Ti, Ta, Nb, Cu, Pt, Au, or Ag. The porous metal body 21b may be made of an alloy material mainly including two or more of these metal materials.

The thickness and size of the porous metal body 21b are not particularly limited. In particular, the size thereof is set as appropriate in accordance with the size of the insulating substrate 10. In the present example embodiment, for example, the porous metal body 21b is made of Ni and has a thickness of about 0.2 mm.

The porous metal body 21b preferably includes a sintered body of metal particles. In this case, the metal particles may have any shape, such as, for example, spherical, oval spherical, flat, plate-shaped, or needle-shaped. The particle size of the metal particles is not particularly limited, but the average particle size thereof is, for example, preferably about 600 nm or less, and more preferably about 20 nm or more and about 500 nm or less.

The first dielectric film 22aD not only covers the surface of a portion of the porous metal body 21b located on the outermost side of the capacitance generating portion 20D, but also covers a surface of the surface of a portion of the porous metal body 21b located inside the capacitance generating portion 20D defined by the above-described fine pores that are not closed by the porous metal body.

The conductive film 23D covers the surface of a portion of the first dielectric film 22aD other than a portion defining the outer edge portion of the capacitance generating portion 20D in the direction parallel to the first main surface 10a of the insulating substrate 10 (i.e., both end portions in the right-left direction in FIG. 32). Accordingly, the first dielectric film 22aD includes a non-exposed portion 221D that is covered by the conductive film 23D and an exposed portion 222D that is not covered by the conductive film 23D.

More specifically, as illustrated in FIG. 32 and FIG. 33A, of the first dielectric film 22aD, a portion other than a portion defining the outer edge portion of the capacitance generating portion 20D in the direction parallel or substantially parallel to the first main surface 10a of the insulating substrate 10 has its surface covered by the conductive film 23D, thus defining and functioning as the non-exposed portion 221D. On the other hand, as illustrated in FIG. 32 and FIG. 33B, the portion of the first dielectric film 22aD defining the outer edge portion has its surface not covered by the conductive film 23D, thus defining and functioning as the exposed portion 222D.

In other words, the outer edge portion of the capacitance generating portion 20D in the direction parallel or substantially parallel to the first main surface 10a is defined by the exposed portion 222D defined by the first dielectric film 22aD. Thus, the outer edge portion of the surface of the capacitance generating portion 20D has an MI structure.

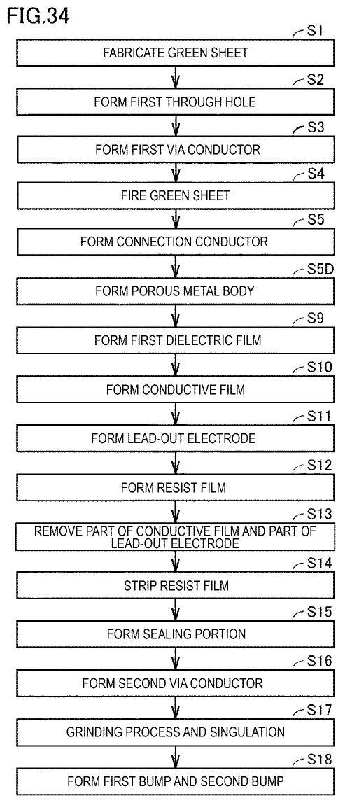

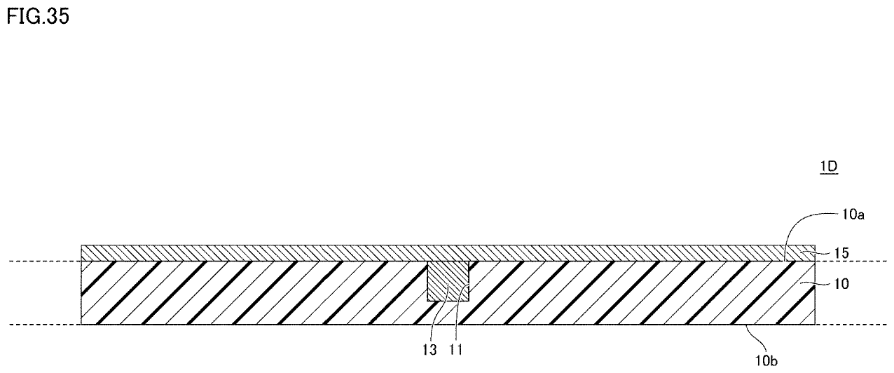

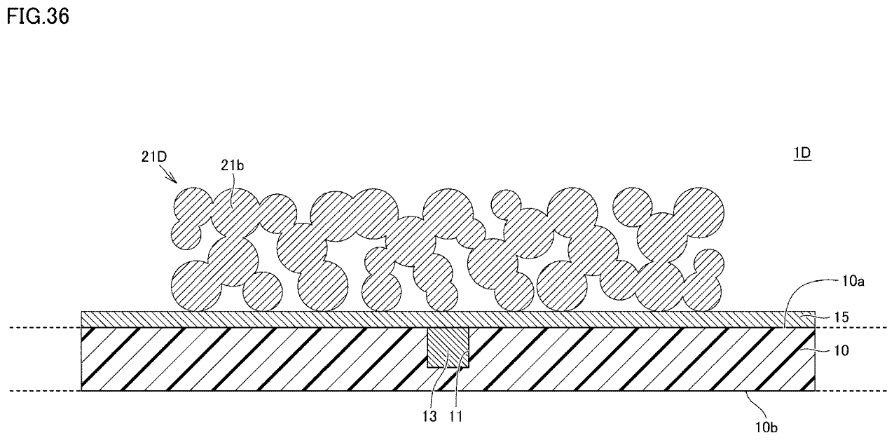

FIG. 34 is a flowchart illustrating a method of manufacturing a capacitor according to the present example embodiment. FIG. 35 and FIG. 36 are schematic sectional views for describing the individual steps of the manufacturing flow illustrated in FIG. 34. Now, an example of a specific manufacturing method for manufacturing the above-described capacitor 1D according to the present example embodiment will be described with reference to FIG. 34 to FIG. 36.

As illustrated in FIG. 34, the method of manufacturing the capacitor 1D mostly follows the method of manufacturing the capacitor 1A. Thus, the steps in the method of manufacturing the capacitor 1D that are the same or substantially the same as those in the method of manufacturing the capacitor 1A will not be described, and only the steps that are different from those in the method of manufacturing the capacitor 1A will be described.

As illustrated in FIG. 34, the method of manufacturing the capacitor 1D is different from the method of manufacturing the capacitor 1A (see FIG. 4 and so forth) in that step S5D is performed instead of steps S6 to S8.

Specifically, after the insulating substrate as illustrated in FIG. 35 is obtained through the above-described steps S1 to S5, a porous metal body is formed in step S5D as illustrated in FIG. 34 and FIG. 36.

More specifically, first, conductive metal particles, an organic solvent such as terpineol, and an ethyl cellulose varnish are weighed and mixed, and then a conductive paste is produced from the mixture using a rolling mill. The conductive paste produced in this manner is applied onto the first main surface 10a of the insulating substrate 10 and dried.

At this time, the conductive paste is applied in multiple layers, thus being applied onto the insulating substrate 10 so as to have a predetermined thickness and a pattern shape that is rectangular or substantially rectangular in plan view as a whole. The individual layers of the conductive paste applied onto the insulating substrate 10 define and function as the porous metal body 21b described above.

Next, the insulating substrate 10 having the conductive paste applied thereto is degreased, and then the conductive paste is fired under temperature conditions of about 400° C. to about 900° C. in a reducing atmosphere, for example, a mixture of nitrogen and hydrogen. Accordingly, adjacent metal particles included in the conductive paste form necks, and metal junctions are formed between the connection conductor 15 and the metal particles in contact therewith. As a result, the porous metal body 21b is formed, and the porous metal body 21b is joined to the connection conductor 15.

The atmosphere during firing is preferably a reducing atmosphere as described above, but can be set to, for example, an atmosphere at or below the equilibrium oxygen partial pressure of the metal selected as the main component of the porous metal body 21b.

The steps after the porous metal body 21b is formed in this manner are basically the same as steps S9 to S18 in the method of manufacturing the capacitor 1A. Through these steps, the above-described capacitor 1D according to the fourth example embodiment is manufactured.

Also in this configuration, advantageous effects the same as or similar to those described in the foregoing first example embodiment can be obtained, and the reliability after mounting can be increased in the capacitor including a capacitance generating portion that includes a conductive structure, a dielectric film, and a conductive film.

In the capacitor 1D according to the present example embodiment, the porous metal body 21b includes a sintered body of metal particles, as described above. In this configuration, the metal particles are metallically joined to each other, which improves the mechanical strength of the capacitance generating portion 20D and also increases the joining area between the metal particles. This makes it possible to achieve low equivalent series resistance (ESR). Furthermore, it is also possible to obtain an advantageous effect that a porous metal body including open pores can be formed relatively easily.

It is possible to combine the capacitor 1D according to the present example embodiment with the characteristic configuration of the capacitor 1A1 according to the first modification based on the above-described first example embodiment, in which electrical lead-out of the capacitance generating portion by the first external connection wiring line is performed from the outer surface side of the sealing portion, similar to the second external connection wiring line. It is also possible to combine the capacitor 1D with the characteristic configuration of the capacitor 1A2 according to the second modification based on the above-described first example embodiment, in which electrical lead-out of the capacitance generating portion by the second external connection wiring line is performed from the second main surface side of the insulating substrate, similar the first external connection wiring line.

Here, when the structure 21D includes the porous metal body 21b, as in the capacitor 1D according to the present example embodiment, the thickness of the sealing portion 30 is measured, for example, by observing the section orthogonal or substantially orthogonal to the extension direction of the first main surface 10a of the insulating substrate 10 by using an optical microscope.

Specifically, when the longitudinal direction of the capacitor 1D is Lx, the shorter direction of the capacitor 1D is Ly, and the thickness direction of the capacitor 1D (i.e., the normal direction of the first main surface 10a) is Lz in plan view of the capacitor 1D, the capacitor 1D is first polished so that a Lx-Lz section of the capacitor 1D in the portion located at the center in the Ly direction is exposed. The polishing process is performed so that the exposed section is located within an error range of, for example, about ±100 μm in the Ly direction with reference to the center position.

Next, of the exposed section, a portion near the outer surface 30a is observed at a magnification of about 1000 times by using an optical microscope. The observation range of the section in the Lx direction is within a range of about ±50 μm with reference to the center position of the section in the Lx direction.

Next, in the observation range of the section, the thickness of the sealing portion 30 in the Lz direction is measured at ten points equally or substantially equally spaced in the Lx direction, and the average value of these measurements is calculated. The average value calculated in this manner is the thickness of the sealing portion 30. Here, in FIG. 33A, three of the thicknesses of the sealing portion 30 in the Lz direction measured at the ten points are illustrated as line segment lengths e1, e2, and e3.

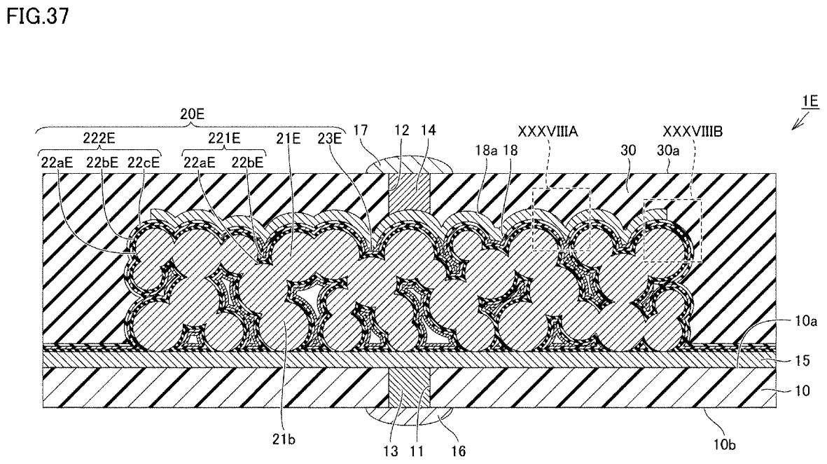

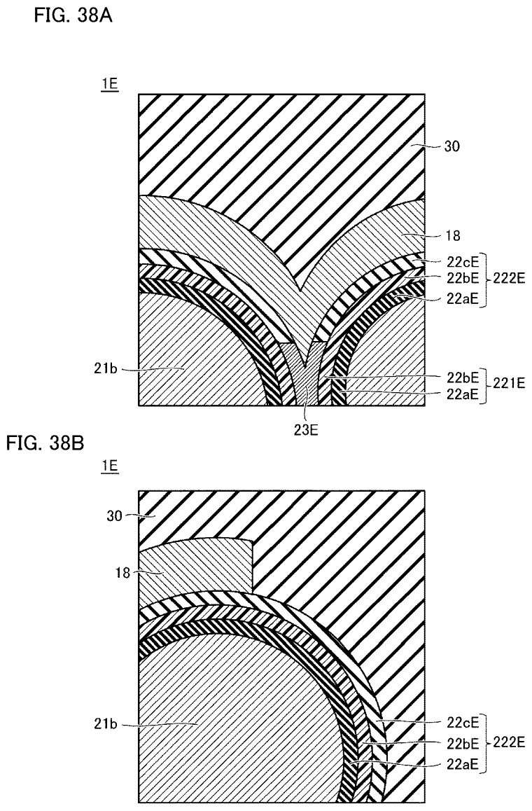

FIG. 37 is a schematic sectional view of a capacitor according to a fifth example embodiment of the present invention. FIGS. 38A and 38B are enlarged main-portion sectional views of region XXXVIIIA and region XXXVIIIB, respectively, of a capacitance generating portion illustrated in FIG. 37. Hereinafter, a capacitor 1D according to the present example embodiment will be described with reference to FIG. 37 and FIGS. 38A and 38B.

As illustrated in FIG. 37, the capacitor 1E according to the present example embodiment is different from the above-described capacitor 1B according to the second example embodiment in the configuration of a capacitance generating portion 20E.

The capacitance generating portion 20E includes a conductive structure 21E, a dielectric film including a first dielectric film 22aE, a second dielectric film 22bE, and a third dielectric film 22cE, and a conductive film 23E.

The structure 21E and the first dielectric film 22aE have configurations the same as or similar to those of the structure 21D and the first dielectric film 22aD according to the above-described the fourth example embodiment, respectively.

The second dielectric film 22bE covers the entire or substantially the entire surface of the first dielectric film 22aE. The third dielectric film 22cE covers a portion of the surface of the second dielectric film 22bE. More specifically, the third dielectric film 22cE covers the surface of a portion of the second dielectric film 22bE defining the outer edge portion in the direction parallel or substantially parallel to the first main surface 10a of the insulating substrate 10 (i.e., both end portions in the right-left direction in FIG. 37) and an end portion on the outer surface 30a side of the sealing portion 30 in the normal direction of the first main surface 10a (i.e., the end portion in the upward direction in FIG. 37).

The conductive film 23E covers the surface of the portion of the second dielectric film 22bE that is not covered by the third dielectric film 22cE. Accordingly, the dielectric film includes a non-exposed portion 221E that is covered by the conductive film 23E and an exposed portion 222E that is not covered by the conductive film 23E.

More specifically, as illustrated in FIG. 37 and FIG. 38A, the portion of the second dielectric film 22bE that is not covered by the third dielectric film 22cE has its surface covered by the conductive film 23E. Accordingly, the first dielectric film 22aE and the second dielectric film 22bE define the non-exposed portion 221E.

On the other hand, as illustrated in FIG. 37 and FIG. 38B, the portion of the second dielectric film 22bE that is covered by the third dielectric film 22cE has its surface not covered by the conductive film 23E. Accordingly, the first dielectric film 22aE, the second dielectric film 22bE, and the third dielectric film 22cE define the exposed portion 222E.

In other words, at least the outer edge portion of the capacitance generating portion 20E in the direction parallel or substantially parallel to the first main surface 10a is defined by the exposed portion 222E defined by the first dielectric film 22aE, the second dielectric film 22bE, and the third dielectric film 22cE. Thus, the outer edge portion of the surface of the capacitance generating portion 20E has an MI structure.

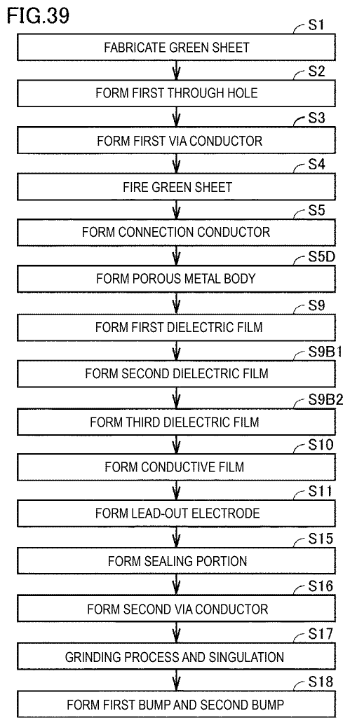

FIG. 39 is a flowchart illustrating a method of manufacturing a capacitor according to the present example embodiment. As illustrated in FIG. 39, the method of manufacturing the capacitor 1E is different from the method of manufacturing the capacitor 1B (see FIG. 21) in that step S5D is performed instead of steps S6 to S8. Step S5D has been described in detail in the description of the method of manufacturing the capacitor 1D, and thus a detailed description of the individual steps of the method of manufacturing the capacitor 1E is omitted here.

Also in this configuration, advantageous effects the same as or similar to those described in the foregoing second and fourth example embodiments can be obtained, and the reliability after mounting can be increased in the capacitor including a capacitance generating portion that includes a conductive structure, a dielectric film, and a conductive film.

It is possible to combine the capacitor 1E according to the present example embodiment with the characteristic configuration of the capacitor 1A1 according to the first modification based on the above-described first example embodiment, in which electrical lead-out of the capacitance generating portion by the first external connection wiring line is performed from the outer surface side of the sealing portion, similar to the second external connection wiring line. It is also possible to combine the capacitor 1E with the characteristic configuration of the capacitor 1A2 according to the second modification based on the above-described first example embodiment, in which electrical lead-out of the capacitance generating portion by the second external connection wiring line is performed from the second main surface side of the insulating substrate, similar to the first external connection wiring line.

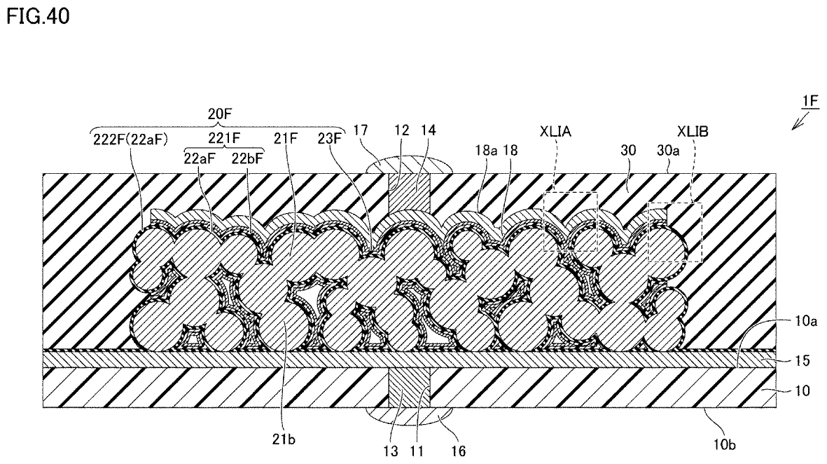

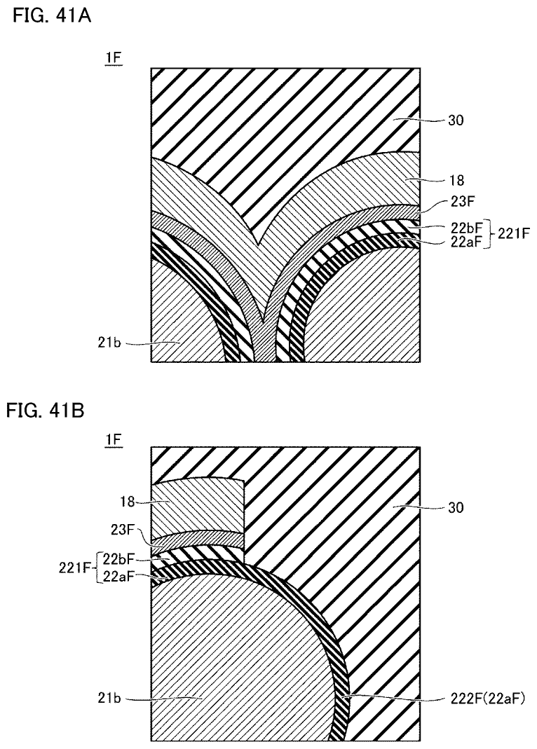

FIG. 40 is a schematic sectional view of a capacitor according to a sixth example embodiment of the present invention. FIGS. 41A and 41B are enlarged main-portion sectional views of region XLIA and region XLIB, respectively, of a capacitance generating portion illustrated in FIG. 40. Hereinafter, a capacitor 1F according to the present example embodiment will be described with reference to FIG. 40 and FIGS. 41A and 41B.

As illustrated in FIG. 40, the capacitor 1F according to the present example embodiment is different from the above-described capacitor 1C according to the third example embodiment in the configuration of a capacitance generating portion 20F.

The capacitance generating portion 20F includes a conductive structure 21F, a dielectric film including a first dielectric film 22aF and a second dielectric film 22bF, and a conductive film 23F.

The structure 21F and the first dielectric film 22aF have configurations the same as or similar to those of the structure 21D and the first dielectric film 22aD according to the above-described the fourth example embodiment, respectively.

The second dielectric film 22bF covers a portion of the surface of the first dielectric film 22aF. More specifically, the second dielectric film 22bF covers the surface of a portion of the first dielectric film 22aF other than a portion defining the outer edge portion in the direction parallel or substantially parallel to the first main surface 10a of the insulating substrate 10 (i.e., both end portions in the right-left direction in FIG. 40). The conductive film 23F covers the entire or substantially the entire surface of the second dielectric film 22bF.

Accordingly, the dielectric film includes a non-exposed portion 221F that is covered by the conductive film 23F and an exposed portion 222F that is not covered by the conductive film 23F.

More specifically, as illustrated in FIG. 40 and FIG. 41A, the entire or substantially the entire surface of the second dielectric film 22bF is covered by the conductive film 23F. Accordingly, the first dielectric film 22aF and the second dielectric film 22bF define the non-exposed portion 221F.

On the other hand, as illustrated in FIG. 40 and FIG. 41B, the portion of the first dielectric film 22aF covered by the second dielectric film 22bF (i.e., of the first dielectric film 22aF, a portion defining the outer edge portion in the direction parallel or substantially parallel to the first main surface 10a of the insulating substrate 10) has its surface not covered by the conductive film 23F. Accordingly, the first dielectric film 22aF defines the exposed portion 222F.

In other words, the outer edge portion of the capacitance generating portion 20F in the direction parallel or substantially parallel to the first main surface 10a is defined by the exposed portion 222F defined by the first dielectric film 22aF. Thus, the outer edge portion of the surface of the capacitance generating portion 20F has an MI structure.

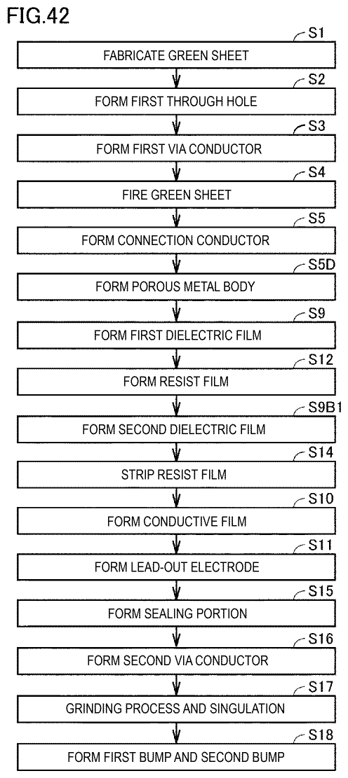

FIG. 42 is a flowchart illustrating a method of manufacturing a capacitor according to the present example embodiment. As illustrated in FIG. 42, the method of manufacturing the capacitor 1F is different from the method of manufacturing the capacitor 1C (see FIG. 27) in that step S5D is performed instead of steps S6 to S8. Step S5D has been described in detail in the description of the method of manufacturing the capacitor 1D, and thus a detailed description of the individual steps of the method of manufacturing the capacitor 1F is omitted here.

Also in this configuration, advantageous effects the same as or similar to those described in the foregoing third and fourth example embodiments can be obtained, and the reliability after mounting can be increased in the capacitor including a capacitance generating portion that includes a conductive structure, a dielectric film, and a conductive film.

It is possible to combine the capacitor 1F according to the present example embodiment with the characteristic configuration of the capacitor 1A1 according to the first modification based on the above-described first example embodiment, in which electrical lead-out of the capacitance generating portion by the first external connection wiring line is performed from the outer surface side of the sealing portion, similar to the second external connection wiring line. It is also possible to combine the capacitor 1F with the characteristic configuration of the capacitor 1A2 according to the second modification based on the above-described first example embodiment, in which electrical lead-out of the capacitance generating portion by the second external connection wiring line is performed from the second main surface side of the insulating substrate, similar to the first external connection wiring line.

FIG. 43 is a schematic sectional view of a capacitor according to a seventh example embodiment of the present invention. Hereinafter, a capacitor 1G according to the present example embodiment will be described with reference to FIG. 43.

As illustrated in FIG. 43, the capacitor 1G according to the present example embodiment is different from the above-described capacitor 1D according to the fourth example embodiment in that the above-described moisture-resistant protective film 40 is used instead of the sealing portion 30. The capacitance generating portion 20D is sealed by the insulating substrate 10 and the moisture-resistant protective film 40. This improves the moisture resistance of the capacitor 1G.

The connection conductor 15 is disposed so as to cover the entire or substantially the entire first main surface 10a, as described above. The connection conductor 15 interposed between the insulating substrate 10 and the structure 21D in this manner includes an outer side portion 15a that is located outward relative to the structure 21D in the direction parallel or substantially parallel to the first main surface 10a and that extends to reach the edge portion of the insulating substrate 10.

The first dielectric film 22aD also covers the surface of the portion of the connection conductor 15 that is not joined to the structure 21D. Specifically, the surface of the outer side portion 15a located opposite to the side facing the insulating substrate 10 is covered by the exposed portion 222D of the first dielectric film 22aD. Thus, the outer end of the exposed portion 222D extends to the edge portion of the insulating substrate 10.

Here, the following three paths are assumed as a path along which moisture enters the MIM structure from the outside of the capacitor.

The first path is a path extending from an outer surface 40a of the moisture-resistant protective film 40 in the thickness direction of the capacitor 1D (i.e., the normal direction of the first main surface 10a), through a first interface between the second via conductor 14 and the moisture-resistant protective film 40 and a second interface between the moisture-resistant protective film 40 and the lead-out electrode 18, to the conductive film 23D (see the path RT1 in FIG. 43).

The second path is a path extending from the outer end of the exposed portion 222D in the direction parallel or substantially parallel to the first main surface 10a, through a third interface between the moisture-resistant protective film 40 and the exposed portion 222D, to the conductive film 23D (see the path RT2 in FIG. 43).

The third path is a path extending from the outer edge of the outer side portion 15a in the direction parallel or substantially parallel to the first main surface 10a, through a fourth interface between the exposed portion 222D and the connection conductor 15, to the structure 21D (see the path RT3 in FIG. 43).

When the distance of the shortest path of the path RT1 is represented by R1, the distance of the shortest path of the path RT2 is represented by R2, and the distance of the shortest path of the path RT3 is represented by R3, the second via conductor 14 is provided so as to satisfy R1>R2 and R1>R3.

This configuration reduces the risk of moisture ingress through the path RT1 causing breakage of the capacitor, as compared with a capacitor configured to satisfy R1<R2 or R1<R3, and in this respect, the moisture resistance of the capacitor 1G is improved.

Furthermore, for example, it is preferable that the shortest distance D (see FIG. 43) in the direction parallel or substantially parallel to the first main surface 10a between the outermost portion of the outer edge portion of the capacitance generating portion 20D in that direction and the edge portion of the insulating substrate 10 in that direction is about 5 μm or more and about 200 μm or less. Accordingly, the lengths of the distance R2 and the distance R3 are sufficiently ensured, and in this respect, the moisture resistance of the capacitor 1G is improved.

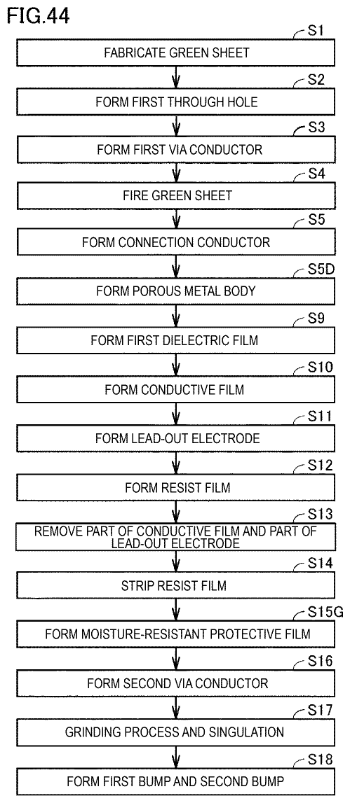

FIG. 44 is a flowchart illustrating a method of manufacturing a capacitor according to the present example embodiment. As illustrated in FIG. 44, the method of manufacturing the capacitor 1G is different from the method of manufacturing the capacitor 1D (see FIG. 34) in that step S15G is performed instead of step S15.

In step S15G, the moisture-resistant protective film 40 is provided on the first main surface 10a of the insulating substrate 10 provided with the capacitance generating portion 20D, so as to cover the capacitance generating portion 20D and the lead-out electrode 18. The moisture-resistant protective film 40 is formed by, for example, CVD, ALD, or the like.

Also in this configuration, advantageous effects the same as or similar to those described in the foregoing fourth example embodiment can be obtained, and the reliability after mounting can be increased in the capacitor including a capacitance generating portion that includes a conductive structure, a dielectric film, and a conductive film.

It is possible to combine the above-described characteristic configuration of the capacitor 1G according to the present example embodiment with a configuration in which the structure includes a plurality of columnar bodies, as in the capacitors 1A to 1C according to the first to third example embodiments.

In the present example embodiment described above, the case where the moisture-resistant protective film 40 is provided has been described as an example, but a combination of the sealing portion 30 and the moisture-resistant protective film 40 may be provided instead of the moisture-resistant protective film 40.

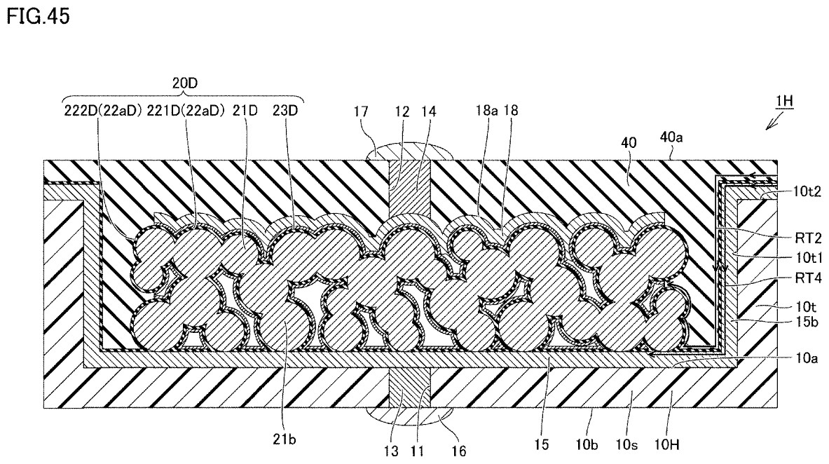

FIG. 45 is a schematic sectional view of a capacitor according to an eighth example embodiment of the present invention. Hereinafter, a capacitor 1H according to the present example embodiment will be described with reference to FIG. 45.

As illustrated in FIG. 45, the capacitor 1H according to the present example embodiment is different from the above-described capacitor 1D according to the fourth example embodiment mainly in that the above-described moisture-resistant protective film 40 is provided instead of the sealing portion 30 and in the configuration of an insulating substrate 10H. The capacitance generating portion 20D is sealed by the insulating substrate 10H and the moisture-resistant protective film 40.

Specifically, the insulating substrate 10H includes a flat-plate-shaped base portion 10s including the first main surface 10a and the second main surface 10b, and a peripheral wall portion 10t extending from a peripheral edge portion of the base portion 10s.

The capacitance generating portion 20D is disposed in a recessed portion defined by the base portion 10s and the peripheral wall portion 10t. The moisture-resistant protective film 40 having a predetermined thickness is interposed between the capacitance generating portion 20D and the peripheral wall portion 10t in the direction parallel or substantially parallel to the first main surface 10a.

The connection conductor 15 includes an extended portion 15b that is disposed continuously on a portion of the first main surface 10a located outward relative to the structure 21D in the direction parallel or substantially parallel to the first main surface 10a, on an inner side surface 10t1 of the peripheral wall portion 10t, and on a top surface 10t2 of the peripheral wall portion 10t. The extended portion 15b extends to the outer end portion of the top surface 10t2 of the peripheral wall portion 10t in the direction parallel or substantially parallel to the first main surface 10a.

The first dielectric film 22aD also covers the surface of the portion of the connection conductor 15 that is not joined to the structure 21D. Specifically, the surface of the extended portion 15b located opposite to the side facing the insulating substrate 10 is covered by the exposed portion 222D of the first dielectric film 22aD. Thus, the outer end of the exposed portion 222D extends to the edge portion of the insulating substrate 10.

The capacitor 1H according to the present example embodiment can be manufactured basically in accordance with the method of manufacturing the capacitor 1G according to the seventh example embodiment described above.

Also in this configuration, advantageous effects the same as or similar to those described in the foregoing fourth example embodiment can be obtained, and the reliability after mounting can be increased in the capacitor including a capacitance generating portion that includes a conductive structure, a dielectric film, and a conductive film.

Furthermore, as a result of the insulating substrate 10H being configured to have a recessed or substantially recessed shape, the distances of the shortest paths of the above-described path RT2 and the path extending from the outer edge of the extended portion 15b in the direction parallel or substantially parallel to the first main surface 10a, through a fifth interface between the exposed portion 222D and the connection conductor 15, to the structure 21D (see the path RT4 in FIG. 45) are longer than when the insulating substrate 10H is flat-plate-shaped. As a result, the moisture resistance of the capacitor 1H is improved.

Furthermore, in the present example embodiment, the position of the top surface 10t2 of the peripheral wall portion 10t in the thickness direction of the capacitor 1H is located outward relative to the position of the capacitance generating portion 20D in the thickness direction of the capacitor 1H. Accordingly, the distances of the shortest paths of the path RT2 and the path RT4 are sufficiently ensured, and as a result the moisture resistance of the capacitor 1H is further improved.

It is possible to combine the above-described characteristic configuration of the capacitor 1H according to the present example embodiment with a configuration in which the structure is formed of a plurality of columnar bodies, as in the capacitors 1A to 1C according to the first to third example embodiments.

In the present example embodiment described above, the case where the moisture-resistant protective film 40 is provided has been described as an example, but a combination of the sealing portion 30 and the moisture-resistant protective film 40 may be provided instead of the moisture-resistant protective film 40.

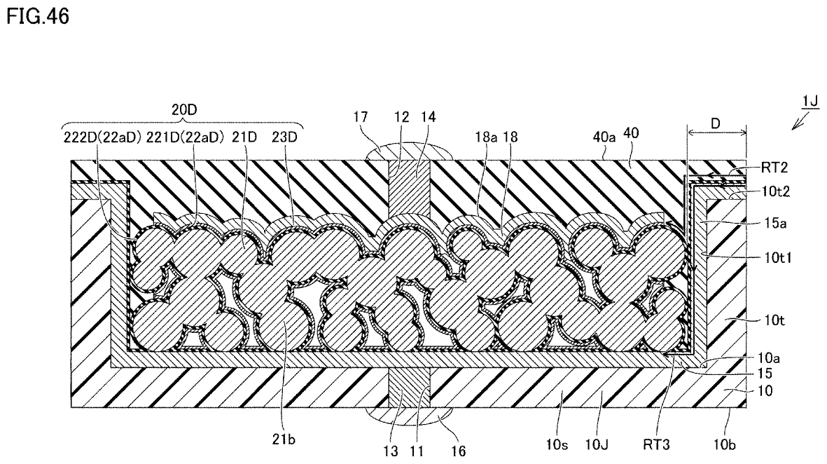

FIG. 46 is a schematic sectional view of a capacitor according to a ninth example embodiment of the present invention. Hereinafter, a capacitor 1J according to the present example embodiment will be described with reference to FIG. 46.

As illustrated in FIG. 46, the capacitor 1J according to the present example embodiment is different from the above-described capacitor 1D according to the fourth example embodiment mainly in that the above-described moisture-resistant protective film 40 is provided instead of the sealing portion 30 and in the configuration of an insulating substrate 10J. The capacitance generating portion 20D is sealed by the insulating substrate 10J and the moisture-resistant protective film 40.

Specifically, the insulating substrate 10J includes the flat-plate-shaped base portion 10s including the first main surface 10a and the second main surface 10b, and the peripheral wall portion 10t extending from the peripheral edge portion of the base portion 10s. The position of the top surface 10t2 of the peripheral wall portion 10t in the thickness direction of the capacitor 1J is located outward relative to the position of the capacitance generating portion 20D in the thickness direction of the capacitor 1J. The capacitance generating portion 20D is disposed in a recessed portion defined by the base portion 10s and the peripheral wall portion 10t.

The connection conductor 15 includes the outer side portion 15a that is disposed continuously on the inner side surface 10t1 of the peripheral wall portion 10t and on the top surface 10t2 of the peripheral wall portion 10t. The outer side portion 15a is located outward relative to the structure 21D in the direction parallel or substantially parallel to the first main surface 10a. The outer side portion 15a extends to the outer end portion of the top surface 10t2 of the peripheral wall portion 10t in the direction parallel or substantially parallel to the first main surface 10a.

The first dielectric film 22aD also covers the surface of the portion of the connection conductor 15 that is not joined to the structure 21D. Specifically, the surface of the outer side portion 15a located opposite to the side facing the insulating substrate 10 is covered by the exposed portion 222D of the first dielectric film 22aD. Thus, the outer end of the exposed portion 222D extends to the edge portion of the insulating substrate 10.

The outer edge portion of the capacitance generating portion 20D in the direction parallel or substantially parallel to the first main surface 10a is in contact with the exposed portion 222D in the portion located on the inner side surface 10t1 of the peripheral wall portion 10t. It is preferable that the shortest distance D (see FIG. 46) in the direction parallel or substantially parallel to the first main surface 10a between the outermost portion of the outer edge portion of the capacitance generating portion 20D in that direction and the edge portion of the insulating substrate 10 in that direction is, for example, about 5 μm or more and about 200 μm or less. Accordingly, the lengths of the distance R2 and the distance R3 are sufficiently ensured, and as a result, the moisture resistance of the capacitor 1J is improved.

The capacitor 1J according to the present example embodiment can be manufactured basically in accordance with the method of manufacturing the capacitor 1G according to the seventh example embodiment described above.

Also in this configuration, advantageous effects the same as or similar to those described in the foregoing fourth example embodiment can be obtained, and the reliability after mounting can be increased in the capacitor including a capacitance generating portion that includes a conductive structure, a dielectric film, and a conductive film.

It is possible to combine the above-described characteristic configuration of the capacitor 1J according to the present example embodiment with a configuration in which the structure includes a plurality of columnar bodies, as in the capacitors 1A to 1C according to the first to third example embodiments.

In the present example embodiment described above, the case where the moisture-resistant protective film 40 is provided has been described as an example, but a combination of the sealing portion 30 and the moisture-resistant protective film 40 may be provided instead of the moisture-resistant protective film 40.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A capacitor comprising:
an insulating substrate including a main surface;
a capacitance generating portion on the main surface; and
a first external connection wiring line and a second external connection wiring line connected to the capacitance generating portion; wherein
the capacitance generating portion includes an uneven or porous conductive structure connected to the first external connection wiring line, a dielectric film covering a surface of the structure, and a conductive film covering a portion of the dielectric film and connected to the second external connection wiring line;
the capacitance generating portion includes an uneven outermost surface;
the dielectric film includes an exposed portion not covered by the conductive film and a non-exposed portion covered by the conductive film; and
the capacitance generating portion includes an outer edge portion in a direction parallel or substantially parallel to the main surface, the outer edge portion being defined by the exposed portion.

2. The capacitor according to claim 1, wherein
the dielectric film includes a first dielectric film covering the surface of the structure, a second dielectric film covering a surface of the first dielectric film and having adhesion to the conductive film, and a third dielectric film covering a portion of a surface of the second dielectric film and having no adhesion to the conductive film;
the non-exposed portion is defined by the first dielectric film and the second dielectric film; and
the exposed portion is defined by the first dielectric film, the second dielectric film, and the third dielectric film.

3. The capacitor according to claim 1, wherein
the dielectric film includes a first dielectric film covering the surface of the structure, and a second dielectric film covering a surface of the first dielectric film and having adhesion to the conductive film;
the non-exposed portion is defined by the first dielectric film and the second dielectric film; and
the exposed portion is defined by only the first dielectric film.

4. The capacitor according to claim 1, further comprising:
a moisture-resistant protective film on the insulating substrate; wherein
the capacitance generating portion is sealed by the insulating substrate and the moisture-resistant protective film;
the first external connection wiring line includes a first via conductor extending through the insulating substrate in a normal direction of the main surface, and a connection conductor interposed between the insulating substrate and the structure;
the connection conductor is connected to the first via conductor and the structure;
the second external connection wiring line includes a second via conductor extending through the moisture-resistant protective film in the normal direction, and a lead-out electrode on a surface of the capacitance generating portion located opposite to the main surface side, the lead-out electrode covering a portion of the conductive film covering the non-exposed portion;
the lead-out electrode is connected to the second via conductor and the conductive film;
the connection conductor includes an outer side portion located outward relative to the structure in the direction parallel or substantially parallel to the main surface and extending to an edge portion of the insulating substrate;
the outer side portion includes a surface located opposite to a side facing the insulating substrate and being covered by the exposed portion; and
the second via conductor is located so as to satisfy R1>R2 and R1>R3, wherein R1 represents a distance of a shortest path extending from an outer surface of the moisture-resistant protective film in the normal direction to the conductive film through a first interface between the second via conductor and the moisture-resistant protective film and a second interface formed by the moisture-resistant protective film and the lead-out electrode, R2 represents a distance of a shortest path extending from an outer end of the exposed portion in the direction parallel or substantially parallel to the main surface to the conductive film through a third interface between the moisture-resistant protective film and the exposed portion, and R3 represents a distance of a shortest path extending from an outer edge of the outer side portion in the direction parallel or substantially parallel to the main surface to the structure through a fourth interface between the exposed portion and the connection conductor.

5. The capacitor according to claim 1, further comprising:
a moisture-resistant protective film on the insulating substrate; wherein
the capacitance generating portion is sealed by the insulating substrate and the moisture-resistant protective film;
the first external connection wiring line includes a connection conductor interposed between the insulating substrate and the structure and connected to the structure;
the insulating substrate includes a base portion including the main surface and a peripheral wall portion extending from a peripheral edge portion of the base portion;
the capacitance generating portion is located in a recessed portion defined by the base portion and the peripheral wall portion;
the connection conductor includes an extended portion provided continuously on a portion of the main surface located outward relative to the structure in the direction parallel or substantially parallel to the main surface, on an inner side surface of the peripheral wall portion, and on a top surface of the peripheral wall portion, so as to extend to an outer end portion of the top surface of the peripheral wall portion in the direction parallel or substantially parallel to the main surface;
the extended portion includes a surface located opposite to a side facing the insulating substrate and covered by the exposed portion; and
the top surface of the peripheral wall portion in a normal direction of the main surface is located outward relative to the capacitance generating portion in the normal direction.

6. The capacitor according to claim 1, further comprising:
a moisture-resistant protective film on the insulating substrate; wherein
the capacitance generating portion is sealed by the insulating substrate and the moisture-resistant protective film;
the first external connection wiring line includes a connection conductor interposed between the insulating substrate and the structure and connected to the structure;
the connection conductor includes an outer side portion located outward relative to the structure in the direction parallel or substantially parallel to the main surface and extending to an edge portion of the insulating substrate;
the outer side portion includes a surface located opposite to a side facing the insulating substrate and covered by the exposed portion; and
a shortest distance in the direction parallel or substantially parallel to the main surface between an outermost portion of the outer edge portion in the direction parallel or substantially parallel to the main surface and the edge portion of the insulating substrate is about 5 μm or more.

7. The capacitor according to claim 1, wherein the second external connection wiring line is located inward relative to the outer edge portion of the capacitance generating portion in the direction parallel or substantially parallel to the main surface.

8. The capacitor according to claim 1, wherein the structure includes a plurality of columnar bodies extending from the main surface.

9. The capacitor according to claim 1, wherein the structure includes a porous metal body.

10. The capacitor according to claim 1, wherein the structure includes a conductive material including at least one of nickel, aluminum, or tantalum.

11. A method of manufacturing a capacitor, the method comprising:
preparing an insulating substrate including a main surface;
forming a first external connection wiring line on or in the insulating substrate;
forming an uneven or porous conductive structure on the main surface;
forming a first dielectric film so as to cover a surface of the structure after the structure and the first external connection wiring line are connected to each other;
forming a conductive film so as to cover a surface of the first dielectric film, thus forming a capacitance generating portion including the structure, the first dielectric film, and the conductive film and including an uneven outermost surface after the first dielectric film has been formed;
forming a second external connection wiring line connected to the conductive film after the capacitance generating portion has been formed;
forming a resist film so as to cover a portion of a surface of the second external connection wiring line corresponding to a portion other than an outer edge portion of the conductive film in a direction parallel or substantially parallel to the main surface after the conductive film and the second external connection wiring line are connected to each other;
removing a portion of the second external connection wiring line not covered by the resist film, and a portion of the conductive film covered by the portion of the second external connection wiring line after the resist film has been formed; and
removing the resist film after a portion of the second external connection wiring line and a portion of the conductive film have been removed.

12. The method of manufacturing a capacitor according to claim 11, wherein the structure is formed of a plurality of columnar bodies extending from the main surface.

13. The method of manufacturing a capacitor according to claim 11, wherein the structure is formed of a porous metal body.

14. The method of manufacturing a capacitor according to claim 11, wherein the structure is made of a conductive material including at least one of nickel, aluminum, or tantalum.

15. A method of manufacturing a capacitor, the method comprising:
preparing an insulating substrate including a main surface;
forming a first external connection wiring line on or in the insulating substrate;
forming an uneven or porous conductive structure on the main surface;
forming a first dielectric film so as to cover a surface of the structure after the structure and the first external connection wiring line are connected to each other;
forming a second dielectric film having adhesion to a conductive film so as to cover a surface of the first dielectric film after the first dielectric film has been formed;
forming a third dielectric film having no adhesion to the conductive film so as to cover a surface of an outer edge portion of the second dielectric film in a direction parallel or substantially parallel to the main surface after the second dielectric film has been formed;
forming the conductive film so as to cover a surface of a portion of the second dielectric film not covered by the third dielectric film, thus forming a capacitance generating portion including the structure, the first dielectric film, the second dielectric film, the third dielectric film, and the conductive film and including an uneven outermost surface after the third dielectric film has been formed; and
forming a second external connection wiring line connected to the conductive film after the capacitance generating portion has been formed.

16. The method of manufacturing a capacitor according to claim 15, wherein the structure is formed of a plurality of columnar bodies extending from the main surface.

17. The method of manufacturing a capacitor according to claim 15, wherein the structure is formed of a porous metal body.

18. The method of manufacturing a capacitor according to claim 15, wherein the structure is made of a conductive material including at least one of nickel, aluminum, or tantalum.

19. A method of manufacturing a capacitor, the method comprising:
preparing an insulating substrate including a main surface;
forming a first external connection wiring line on or in the insulating substrate;
forming an uneven or porous conductive structure on the main surface;
forming a first dielectric film so as to cover a surface of the structure after the structure and the first external connection wiring line are connected to each other;
forming a resist film so as to cover an outer edge portion of the first dielectric film in a direction parallel or substantially parallel to the main surface after the first dielectric film has been formed;
forming a second dielectric film having adhesion to a conductive film so as to cover the resist film and a portion of the first dielectric film not covered by the resist film after the resist film has been formed;
removing the resist film and a portion of the second dielectric film covering the resist film after the second dielectric film has been formed;
forming, in a state in which the resist film and a portion of the second dielectric film have been removed, the conductive film so as to cover a surface of a portion of the second dielectric film that has not been removed, thus forming a capacitance generating portion including the structure, the first dielectric film, the second dielectric film, and the conductive film and including an uneven outermost surface; and
forming a second external connection wiring line connected to the conductive film after the capacitance generating portion has been formed.

20. The method of manufacturing a capacitor according to claim 19, wherein the structure is formed of a plurality of columnar bodies extending from the main surface.

21. The method of manufacturing a capacitor according to claim 19, wherein the structure is formed of a porous metal body.

22. The method of manufacturing a capacitor according to claim 19, wherein the structure is made of a conductive material including at least one of nickel, aluminum, or tantalum.
